(19) United States
(12) Patent Application Publication
(10) Pub. No.: US 2022/0405752 A1
(43) Pub. Date: Dec. 22, 2022

(54) TIME-LOCKED BLOCKCHAIN TRANSACTIONS AND RELATED BLOCKCHAIN TECHNOLOGY

(71) Applicant: nChain Holdings Limited, St. John's (AG)

(72) Inventors: Jack Owen DAVIES, London (GB); Wei ZHANG, London (GB); Craig Steven WRIGHT, London (GB)

(21) Appl. No.: 17/763,167

(22) PCT Filed: Sep. 17, 2020
(86) PCT No.: PCT/IB2020/058673

§ 371 Date: Mar. 23, 2022

(30) Foreign Application Priority Data
Sep. 27, 2019 (GB) 1913987.2

(51) Int. Cl. G06Q 20/40; G06Q 20/38

(52) U.S. Cl. CPC G06Q 20/401; G06Q 20/3825; G06Q 20/389; G06Q 2220/00; G06Q 20/223

(57) ABSTRACT

A blockchain payment channel based on a series of spending transactions exchanged between parties, in which: a funding transaction, committed to a blockchain, comprises at least one spendable transaction output locked to at least two public keys of the parties, wherein the funding transaction contains or otherwise evidences a function for at least partially computing the series of spending transactions. A previous transaction of the series is received at computer equipment of one of the parties. The function contained or otherwise evidenced in the funding transaction is used to at least partially compute the current transaction. A portion of the current transaction is cryptographically signed by the party, the signed portion comprising the at least two spendable transaction outputs, using a private key counterpart to the public key of the party, thereby computing a transaction signature for inclusion in the transaction input of the current transaction.

### CROSS REFERENCE TO RELATED APPLICATIONS

This application is the U.S. National Stage of International Application No. PCT/IB2020/058673 filed on Sep. 17, 2020, which claims the benefit of United Kingdom Patent Application No. 1913987.2, filed on Sep. 27, 2019, the contents of which are incorporated herein by reference in their entireties.

### TECHNICAL FIELD

The present disclosure pertains generally to a communication framework in which “time-locked” blockchain transactions (or component(s) thereof) are exchanged between entities but only a subset of those transactions (e.g. a single transaction) is generally expected to be committed to a blockchain once its lock time has expired. This disclosure further pertains to steps, systems, computer programs and/or transactions etc. for facilitating such an exchange or otherwise related thereto.

### BACKGROUND

A blockchain refers to a form of distributed data structure, wherein a duplicate copy of the blockchain is maintained at each of a plurality of nodes in a peer-to-peer (P2P) network. The blockchain comprises a chain of blocks of data, wherein each block comprises one or more transactions. Each transaction may point back to a preceding transaction in a sequence which may span one or more blocks. Transactions can be submitted to the network to be included in new blocks. New blocks are created by a process known as “mining”, which involves each of a plurality of mining nodes competing to perform “proof-of-work”, i.e. solving a cryptographic puzzle based on a pool of the pending transactions waiting to be included in blocks.

Conventionally the transactions in the blockchain are used to convey a digital asset, i.e. data acting as a store of value. However, a blockchain can also be exploited in order to layer additional functionality on top of the blockchain. For instance, blockchain protocols may allow for storage of additional user data in an output of a transaction. Modern blockchains are increasing the maximum data capacity that can be stored within a single transaction, enabling more complex data to be incorporated. For instance this may be used to store an electronic document in the blockchain, or even audio or video data.

Each node in the network can have any one, two or all of three roles: forwarding, mining and storage. Forwarding nodes propagate transactions throughout the nodes of the network. Mining nodes perform the mining of transactions into blocks. Storage nodes each store their own copy of the mined blocks of the blockchain. In order to have a transaction recorded in the blockchain, a party sends the transaction to one of the nodes of the network to be propagated. Mining nodes which receive the transaction may race to mine the transaction into a new block. Each node is configured to respect the same node protocol, which will include one or more conditions for a transaction to be valid. Invalid transactions will not be propagated nor mined into blocks. Assuming the transaction is validated and thereby accepted onto the blockchain, then the transaction (including any user data) will thus remain stored at each of the nodes in the P2P network as an immutable public record.

The miner who successfully solved the proof-of-work puzzle to create the latest block is typically rewarded with a new transaction called a “generation transaction” which generates a new amount of the digital asset. The proof-of work incentivises miners not to cheat the system by including double-spending transactions in their blocks, since it requires a large amount of computational resource to mine a block, and a block that includes an attempt to double spend is likely not be accepted by other nodes.

In an “output-based” model (sometimes referred to as a UTXO-based model), the data structure of a given transaction comprises one or more inputs (transaction inputs) and one or more outputs (transaction outputs). Any spendable output comprises an element specifying an amount of the digital asset, sometimes referred to as a UTXO (“unspent transaction output”). The output may further comprise a locking script specifying a condition for redeeming the output. Each input comprises a pointer to such an output in a preceding transaction and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the P2P network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it nor include it for mining into a block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the miners separate to the blockchain and is updated constantly.

At least one blockchain protocol in use today defines the related concepts of “sequence numbers” and “lock times”. In one particular UTXO-based model, the (or each) input of a transaction has a sequence number which can a take values between a maximum and a minimum sequence number (e.g. 0x00000000 to 0xFFFFFFFF in hexadecimal notation). A transaction can also have a defined lock time, and can only become valid after that lock time has expired (even if, before that point in time, it satisfied all of the other requirements of validity). Before that point in time, the transaction is said to be “time locked”. Sequence numbers together with lock times provide certainty in a situation in which multiple versions of the same transaction are created (or, more precisely, when multiple transactions which all satisfy the condition(s) for unlocking the same output(s) are created). Without a defined lock time, the creation of two such transactions would lead to “double spending” uncertainty: both transactions could be submitted to a blockchain network for validation, and it would not necessarily be possible to predict with any certainty which of these would end up getting mined into a valid block (at which point the other would become invalid).

However, a transaction with a defined future lock time cannot become valid until that lock time expires. Moreover, if two otherwise-valid transactions are submitted to the blockchain network which unlock the same output(s) and which have expired lock times, only the transaction with the higher sequence number will be accepted as valid by miners—the transaction number with the lower sequence number will be invalid, even though its lock time has expired, and even though it satisfies all of the other validity requirements.

### SUMMARY

Sequence numbers and lock times can be used to implement a particular form of blockchain payment channel. In a blockchain context, the term “payment channel” refers to a particular form of “off-chain” communication between two or more parties to the payment channel (participants). A payment channel can be used to exchange a series of spending transactions, for unlocking the same output(s), and having future lock times and incrementing sequence numbers. Each spending transaction may be valid but for the fact that its lock time has not yet expired, and subject to an equally valid spending transaction being created with a higher sequence number before that point in time. This provides a secure technical framework in which two or more parties can negotiate—in the expectation that they will be able to reach a mutually agreed settlement transaction to terminate the negotiation, but with each party having the option of publishing the spending transaction with the highest sequence number, upon expiry of its lock time, in the event of the other party/parties terminating the negotiation prematurely or otherwise acting in bad faith.

A similar outcome could be achieved by simply committing an agreed transaction to the blockchain at every step of the negotiation. However, that would require significantly more time and computational resources to process each transaction and wait for the necessary level of consensus to be reached—typically the parties would have to wait not only for the transaction to be mined into a block, but also for several more blocks to be mined in order for the blockchain network to reach a consensus as to the block's validity, before proceeding to the next step of the negotiation. For a negotiation with a large number of steps, this would be extremely inefficient both in terms of the time delay and the computational resources needed to process so many transactions within the blockchain network.

The present disclosure pertains generally to a novel framework for implementing blockchain “payment channels”. It is important to note that, notwithstanding the terminology, the present payment channels are not limited to negotiated payment—in general, a payment channel of the present disclosure provides a computationally efficient way to conduct off-chain communication in a secure manner according to an agreed set of rules. A core issue addressed herein is that of balancing efficiency (both in terms of time and computational resources) and security in the context of a blockchain payment channel. Security in the present context means the extent to which the payment channel is robust to one party (or parties) violating the agreed rules of the payment channel.

According to one aspect disclosed herein, there is provided computer-implemented method of effecting a blockchain payment channel based on a series of spending transactions exchanged between parties, in which: a funding transaction, committed to a blockchain, comprises at least one spendable transaction output locked to at least two public keys of the parties, wherein the funding transaction contains or otherwise evidences a function for at least partially computing the series of spending transactions; each transaction of the series of spending transactions has a future lock time, before which it cannot be committed to the blockchain, and comprises: (i) at least one transaction input containing a pointer to the spendable transaction output of the funding transaction, and (ii) at least two spendable transaction outputs having respective digital asset values, an initial transaction of the series of spending transactions has a lowest sequence number and each subsequent transaction of the series of spending transactions has a higher sequence number than the previous transaction; wherein the method comprises, by one of the parties: receiving, at computer equipment of the party, a previous transaction of the series of spending transaction; using the function contained or otherwise evidenced in the funding transaction to at least partially compute the current transaction; and cryptographically signing a portion of the current transaction, the signed portion comprising the at least two spendable transaction outputs, using a private key counterpart to the public key of the party, thereby computing a transaction signature for inclusion in the transaction input of the current transaction.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 2A shows an example of a funding transaction and two cooperating “loop” transactions

FIG. 3 is a schematic block diagram of another system for implementing a blockchain payment channel,

FIG. 3A shows a second example of a system for implementing a blockchain payment channel,

FIG. 3B shows a third example of a system for implementing a blockchain payment channel,

FIG. 4A is a schematic block diagram of a client application,

FIG. 4B is a schematic block diagram of some node software for processing transactions,

FIG. 4C is a schematic mock-up of an example user interface that may be presented by the client application of FIG. 4A,

FIG. 5 conceptually illustrates how spending relationships are established between blockchain transactions in a UTXO model,

FIGS. 6A, 6A and 6B show example process flows for implementing a “payment channel loop”,

FIG. 7 shows one example of a “for” payment channel loop,

FIG. 8 shows how loop transaction may be iteratively created, using a defined functional unit,

FIGS. 9A and 9B show examples for different “2-out-ot-2” funding transactions for establishing a secure payment channel,

FIG. 10 shows a relationship between a funding transaction and a loop transaction,

FIGS. 11A and 11B show, respectively, an example of a settlement transaction, and its relationship to a funding transaction,

FIGS. 12 to 16 show various example process flows for different implementations of payment channel loops,

FIG. 17 shows a “2-out-of-3” funding transaction,

FIGS. 18A and 18B shows, respectively, a settlement transaction evidencing a series of input values and/or parameters, and a data structure for evidencing the series of transactions.

### DETAILED DESCRIPTION OF EMBODIMENTS

A blockchain is maintained by a blockchain network (a peer-to-peer network of blockchain nodes, each of which performs one or more of a mining role, a forwarding role and a storage role). A “committed” transaction is a transaction which has been validated by a mining node of a blockchain network which maintains the blockchain, and mined by the mining node into a valid block of the blockchain (and thus immutably recorded in the blockchain; for the block to be valid, in practice this will mean that the validity for the transaction has been confirmed by a sufficient number of mining nodes in order to reach a consensus as to the validity of the block). By definition, a committed transaction must be valid with respect to a blockchain protocol of the blockchain network.

By contrast, a “published” transaction is a transaction which has been submitted to a node the blockchain network for validation (by that node and/or other node(s) of the blockchain network), but has not yet mined into a block, and which may or may not be valid. A published transaction will not necessarily ever be mined (i.e. it may or may not be mined in due course, depending on the circumstances). For example, a published transaction may be held in a mining pool of transactions which are potential candidates for being mined (and may be visible to other users of the blockchain), but has not yet been immutably recorded in the blockchain, and may never be because it may or may not be valid.

The phrase “receiving, at computer equipment of the party, a previous transaction of the series of spending transaction” encompasses not only receipt from a remote source, such as computer equipment of one of the other parties, but also local receiving, e.g. from local storage of the computer equipment of the same party. For example, the previous transaction may have been created (or at least finalized) by another of the parties, and received from that party, or it may have been created (or at least finalized) by the same party and stored locally to enable that same party to create (but not necessarily finalize) the current transaction, or at least compute its input value(s) and/or any other relevant component(s) such as its digital asset distribution.

In the present context, a transaction is said to be “completed” at the point at which the input of that transaction satisfies the conditions for unlocking the output of the funding transaction—note that a transaction of the series of spending transactions will not necessarily be valid at the point it is completed, even if the structure and contents of the transaction meets all of the validity requirements imposed by a blockchain protocol of the blockchain. This is because the transaction can only become valid after its lock time has been expired and, moreover, will only be valid (i.e. accepted as valid by a consensus of mining nodes) if no other completed spending transaction has been published with a higher sequence number and whose lock time has expired. That is to say, if multiple completed spending transactions are published after their respective lock times have expired, only one of those spending transactions will be accepted as valid by a consensus of mining nodes—that one spending transaction being the one with the highest sequence number.

Since the output of the funding transaction is locked to at least two public keys of the parties, as a minimum two transaction signatures—each valid in respect of a different one of the public keys—will be required to complete the transaction. For example, the point at which a transaction is completed may be the point at which a second of the parties signs the transaction, subsequent to an earlier point at which a first of the second parties signed the transaction.

Note, the terminology “at least one spendable output locked to at least two public keys” does not necessarily imply that the only requirement for unlocking (spending) that output is the provision of two transaction signatures valid in respect of those keys respectively. That is to say, there may or may not be additional unlocking requirement(s) (such as the requirement to provide a solution to a specified hash puzzle etc.). For example, the full locking script could be something like:

[Hash puzzle H(X)] [Multisig 2-of-2],
which means the funds are not entirely (un)locked by the keys, and that there may be an additional minimum requirement to unlock funds, i.e. the provision of a preimage which hashes to H(X).

The verb “to chorographically sign” in this specific context refers to the process of generating a transaction signature for inclusion in the input of the current transaction, by applying a signature generation function to at least the outputs of the spending transaction, using a private key counterpart to that party's public key. The party signing the transaction will not necessarily add the transaction signature to the input of the transaction—for example, it could be sent to another of the parties (or indeed some other external entity) for adding to the input. The party signing a transaction does not necessarily need to be in possession of the whole transaction—only the signed portion is required.

A spending transaction can be created by one party (or indeed by an external entity who is not party to the payment channel) but completed by another party (optionally, with one or more additional parties adding to the transaction in the interim). Alternatively, in the present context, a spending transaction can be created and completed by the same party, but in that event at least one other party needs to provide a valid transaction signature, and will generally require at least the outputs of the transaction in order to do so. The party that applies the function to compute the input value(s) of the current transaction and the distribution of digital asset may or may not create the rest of transaction—for the latter, it would, for example, be sufficient for the function-applying party to simply compute the input value(s), the digital asset distribution and that party's transaction signature, and send them to another entity (e.g. another of the parties) to create the rest of the transaction.

The terms ‘previous transaction’ and ‘current transaction’ are relative terms and can thus refer to any two temporally adjacent transaction in the series (including the case where the previous transaction is the initial transaction, and the case where the current transaction is a final transaction in the series.

The phrase “output locked to at least two public keys of the parties” covers not only the case where a signature is required for every single public key specified in the output, by also an output in which m public keys are specified but the output is locked to any n<m of those public keys (i.e. any subset of n parties can sign the transaction to unlock the output of the funding transaction). In accordance with the terminology applied in the art, this may be referred to as an “n-ofm check multi-sig” (multi-signature) condition in the output of the funding transaction.

This disclosure uses the terminology “n-of-m check multisig” and similar as a convenient shorthand for any locking script that requires transaction signatures for only a subset n of the specified m public keys. There are numerous ways this requirement can be coded in blockchain Script, and the terminology does not imply any particular Script-level implementation. For example, the following alternatives are encompassed by the terminology (among others, including more complex scripts):
1. a ‘bare multisig’, which uses the opcode OP_CHECKMULTISGI(VERIFY),
2. a P2SH (pay to script hash) multisig, where a special script is written to implement this requirement.

The at least two spendable outputs of each spending transaction will typically be constructed for distributing an amount of digital asset between at least two of the parties—although the possibility of constructing spending transactions that distribute the amount of digital asset between other parties is not excluded (e.g. the parties to the payment channel could negotiate or otherwise agree a distribution of digital asset on behalf of some other blockchain parties). Each of those spendable outputs is locked to a public key of a different one of the parties amongst which the digital asset is to be distributed. Where those are the same parties who agree the distribution via the payment channel, that public key may or may not be the same public specified in the spendable output of the funding transaction.

For each spending transaction the distribution of the amount of digital asset is defined by the respective digital asset values of the spending transaction outputs (as determined by the application of the function). Hence, the function together with the one or more input values of the previous transaction defines the distribution of the digital asset between the parties. Of course, that distribution will only be crystallised if and when the transaction is committed to the blockchain—which, in turn, can only happen (a) after the lock time of the transaction has expired and (b) only if no other spending transaction with a higher sequence number is published.

In some contexts, it may be preferable for the one or more function variables to be contained in an output(s) of the transaction, so that the function variable(s) are signed. For example, they may be contained in one or more of the spendable outputs or in one or more separate, unspendable outputs of the transaction.

### 1. Example System Overview

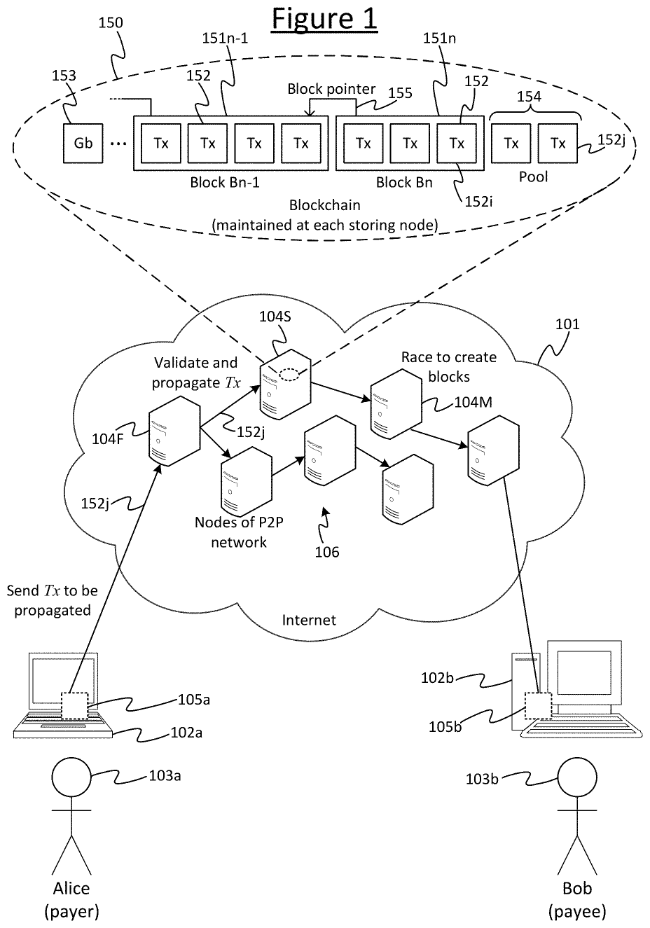

FIG. 1 shows an example system 100 for implementing a blockchain 150. The system 100 comprises a packet-switched network 101, typically a wide-area internetwork such as the Internet. The packet-switched network 101 comprises a plurality of nodes 104 arranged to form a peer-to-peer (P2P) overlay network 106 within the packet-switched network 101. Each node 104 comprises computer equipment of a peers, with different ones of the nodes 104 belonging to different peers. Each node 104 comprises processing apparatus comprising one or more processors, e.g. one or more central processing units (CPUs), accelerator processors, application specific processors and/or field programmable gate arrays (FPGAs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of nodes in the P2P network 160. Each block 151 in the chain comprises one or more transactions 152, wherein a transaction in this context refers to a kind of data structure. The nature of the data structure will depend on the type of transaction protocol used as part of a transaction model or scheme. A given blockchain will typically use one particular transaction protocol throughout. In one common type of transaction protocol, the data structure of each transaction 152 comprises at least one input and at least one output. Each output specifies an amount representing a quantity of a digital asset belonging to a user 103 to whom the output is cryptographically locked (requiring a signature of that user in order to be unlocked and thereby redeemed or spent). Each input points back to the output of a preceding transaction 152, thereby linking the transactions.

At least some of the nodes 104 take on the role of forwarding nodes 104F which forward and thereby propagate transactions 152. At least some of the nodes 104 take on the role of miners 104M which mine blocks 151. At least some of the nodes 104 take on the role of storage nodes 104S (sometimes also called “full-copy” nodes), each of which stores a respective copy of the same blockchain 150 in their respective memory. Each miner node 104M also maintains a pool 154 of transactions 152 waiting to be mined into blocks 151. A given node 104 may be a forwarding node 104, miner 104M, storage node 104S or any combination of two or all of these.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the pool 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the signature of the user 103a to whom the output of the preceding transaction 152i is locked. In turn, the output of the present transaction 152j can be cryptographically locked to a new user 103b. The present transaction 152j can thus transfer the amount defined in the input of the preceding transaction 152i to the new user 103b as defined in the output of the present transaction 152j. In some cases a transaction 152 may have multiple outputs to split the input amount between multiple users (one of whom could be the original user 103a in order to give change). In some cases a transaction can also have multiple inputs to gather together the amounts from multiple outputs of one or more preceding transactions, and redistribute to one or more outputs of the current transaction.

The above may be referred to as an “output-based” transaction protocol, sometimes also referred to as an unspent transaction output (UTXO) type protocol (where the outputs are referred to as UTXOs). A user's total balance is not defined in any one number stored in the blockchain, and instead the user needs a special “wallet” application 105 to collate the values of all the UTXOs of that user which are scattered throughout many different transactions 152 in the blockchain 151.

An alternative type of transaction protocol may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored by the miners separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

With either type of transaction protocol, when a user 103 wishes to enact a new transaction 152j, then he/she sends the new transaction from his/her computer terminal 102 to one of the nodes 104 of the P2P network 106 (which nowadays are typically servers or data centres, but could in principle be other user terminals). This node 104 checks whether the transaction is valid according to a node protocol which is applied at each of the nodes 104. The details of the node protocol will correspond to the type of transaction protocol being used in the blockchain 150 in question, together forming the overall transaction model. The node protocol typically requires the node 104 to check that the cryptographic signature in the new transaction 152j matches the expected signature, which depends on the previous transaction 152i in an ordered sequence of transactions 152. In an output-based case, this may comprise checking that the cryptographic signature of the user included in the input of the new transaction 152j matches a condition defined in the output of the preceding transaction 152i which the new transaction spends, wherein this condition typically comprises at least checking that the cryptographic signature in the input of the new transaction 152j unlocks the output of the previous transaction 152i to which the input of the new transaction points. In some transaction protocols the condition may be at least partially defined by a custom script included in the input and/or output. Alternatively it could simply be a fixed by the node protocol alone, or it could be due to a combination of these. Either way, if the new transaction 152j is valid, the current node forwards it to one or more others of the nodes 104 in the P2P network 106. At least some of these nodes 104 also act as forwarding nodes 104F, applying the same test according to the same node protocol, and so forward the new transaction 152j on to one or more further nodes 104, and so forth. In this way the new transaction is propagated throughout the network of nodes 104.

In an output-based model, the definition of whether a given output (e.g. UTXO) is spent is whether it has yet been validly redeemed by the input of another, onward transaction 152j according to the node protocol. Another condition for a transaction to be valid is that the output of the preceding transaction 152i which it attempts to spend or redeem has not already been spent/redeemed by another valid transaction. Again if not valid, the transaction 152j will not be propagated or recorded in the blockchain. This guards against double-spending whereby the spender tries to spend the output of the same transaction more than once. An account-based model on the other hand guards against double-spending by maintaining an account balance. Because again there is a defined order of transactions, the account balance has a single defined state at any one time.

In addition to validation, at least some of the nodes 104M also race to be the first to create blocks of transactions in a process known as mining, which is underpinned by “proof of work”. At a mining node 104M, new transactions are added to a pool of valid transactions that have not yet appeared in a block. The miners then race to assemble a new valid block 151 of transactions 152 from the pool of transactions 154 by attempting to solve a cryptographic puzzle. Typically this comprises searching for a “nonce” value such that when the nonce is concatenated with the pool of transactions 154 and hashed, then the output of the hash meets a predetermined condition. E.g. the predetermined condition may be that the output of the hash has a certain predefined number of leading zeros. A property of a hash function is that it has an unpredictable output with respect to its input. Therefore this search can only be performed by brute force, thus consuming a substantive amount of processing resource at each node 104M that is trying to solve the puzzle.

The first miner node 104M to solve the puzzle announces this to the network 106, providing the solution as proof which can then be easily checked by the other nodes 104 in the network (once given the solution to a hash it is straightforward to check that it causes the output of the hash to meet the condition). The pool of transactions 154 for which the winner solved the puzzle then becomes recorded as a new block 151 in the blockchain 150 by at least some of the nodes 104 acting as storage nodes 104S, based on having checked the winner's announced solution at each such node. A block pointer 155 is also assigned to the new block 151n pointing back to the previously created block 151n−1 in the chain. The proof-of-work helps reduce the risk of double spending since it takes a large amount of effort to create a new block 151, and as any block containing a double spend is likely to be rejected by other nodes 104, mining nodes 104M are incentivised not to allow double spends to be included in their blocks. Once created, the block 151 cannot be modified since it is recognized and maintained at each of the storing nodes 104S in the P2P network 106 according to the same protocol. The block pointer 155 also imposes a sequential order to the blocks 151. Since the transactions 152 are recorded in the ordered blocks at each storage node 104S in a P2P network 106, this therefore provides an immutable public ledger of the transactions.

Note that different miners 104M racing to solve the puzzle at any given time may be doing so based on different snapshots of the unmined transaction pool 154 at any given time, depending on when they started searching for a solution. Whoever solves their respective puzzle first defines which transactions 152 are included in the next new block 151n, and the current pool 154 of unmined transactions is updated. The miners 104M then continue to race to create a block from the newly defined outstanding pool 154, and so forth. A protocol also exists for resolving any “fork” that may arise, which is where two miners 104M solve their puzzle within a very short time of one another such that a conflicting view of the blockchain gets propagated. In short, whichever prong of the fork grows the longest becomes the definitive blockchain 150.

In most blockchains the winning miner 104M is automatically rewarded with a special kind of new transaction which creates a new quantity of the digital asset out of nowhere (as opposed to normal transactions which transfer an amount of the digital asset from one user to another). Hence the winning node is said to have “mined” a quantity of the digital asset. This special type of transaction is sometime referred to as a “generation” transaction. It automatically forms part of the new block 151n. This reward gives an incentive for the miners 104M to participate in the proof-of-work race. Often a regular (non-generation) transaction 152 will also specify an additional transaction fee in one of its outputs, to further reward the winning miner 104M that created the block 151n in which that transaction was included.

Due to the computational resource involved in mining, typically at least each of the miner nodes 104M takes the form of a server comprising one or more physical server units, or even whole a data centre. Each forwarding node 104M and/or storage node 104S may also take the form of a server or data centre. However in principle any given node 104 could take the form of a user terminal or a group of user terminals networked together.

The memory of each node 104 stores software configured to run on the processing apparatus of the node 104 in order to perform its respective role or roles and handle transactions 152 in accordance with the node protocol. It will be understood that any action attributed herein to a node 104 may be performed by the software run on the processing apparatus of the respective computer equipment. The node software may be implemented in one or more applications at the application layer, or a lower layer such as the operating system layer or a protocol layer, or any combination of these. Also, the term “blockchain” as used herein is a generic term that refers to the kind of technology in general, and does not limit to any particular proprietary blockchain, protocol or service.

Also connected to the network 101 is the computer equipment 102 of each of a plurality of parties 103 in the role of consuming users. These act as payers and payees in transactions but do not necessarily participate in mining or propagating transactions on behalf of other parties. They do not necessarily run the mining protocol. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective user party 103 to create, sign and send transactions 152 to be propagated throughout the network of nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the forwarding nodes 104F of the P2P network 106. This enables the wallet function of the client 105 to send transactions 152 to the network 106. The client 105 is also able to contact one, some or all of the storage nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. Each node 104 runs software configured to validate transactions 152 according to a node protocol, and in the case of the forwarding nodes 104F to forward transactions 152 in order to propagate them throughout the network 106. The transaction protocol and node protocol correspond to one another, and a given transaction protocol goes with a given node protocol, together implementing a given transaction model. The same transaction protocol is used for all transactions 152 in the blockchain 150 (though the transaction protocol may allow different subtypes of transaction within it). The same node protocol is used by all the nodes 104 in the network 106 (though it many handle different subtypes of transaction differently in accordance with the rules defined for that subtype, and also different nodes may take on different roles and hence implement different corresponding aspects of the protocol).

As mentioned, the blockchain 150 comprises a chain of blocks 151, wherein each block 151 comprises a set of one or more transactions 152 that have been created by a proof-of-work process as discussed previously. Each block 151 also comprises a block pointer 155 pointing back to the previously created block 151 in the chain so as to define a sequential order to the blocks 151. The blockchain 150 also comprises a pool of valid transactions 154 waiting to be included in a new block by the proof-of-work process. Each transaction 152 (other than a generation transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one of the one or more forwarding nodes 104F to which she is connected. E.g. this could be the forwarding node 104F that is nearest or best connected to Alice's computer 102. When any given node 104 receives a new transaction 152j, it handles it in accordance with the node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any storage node 104S that receives the transaction 152j will add the new validated transaction 152 to the pool 154 in the copy of the blockchain 150 maintained at that node 104S. Further, any forwarding node 104F that receives the transaction 152j will propagate the validated transaction 152 onward to one or more other nodes 104 in the P2P network 106. Since each forwarding node 104F applies the same protocol, then assuming the transaction 152j is valid, this means it will soon be propagated throughout the whole P2P network 106.

Once admitted to the pool 154 in the copy of the blockchain 150 maintained at one or more storage nodes 104, then miner nodes 104M will start competing to solve the proof-of-work puzzle on the latest version of the pool 154 including the new transaction 152 (other miners 104M may still be trying to solve the puzzle based on the old view of the pool 154, but whoever gets there first will define where the next new block 151 ends and the new pool 154 starts, and eventually someone will solve the puzzle for a part of the pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different nodes 104 may receive different instances of a given transaction first and therefore have conflicting views of which instance is ‘valid’ before one instance is mined into a block 150, at which point all nodes 104 agree that the mined instance is the only valid instance. If a node 104 accepts one instance as valid, and then discovers that a second instance has been recorded in the blockchain 150 then that node 104 must accept this and will discard (i.e. treat as invalid) the unmined instance which it had initially accepted.

### UTXO-Based Model

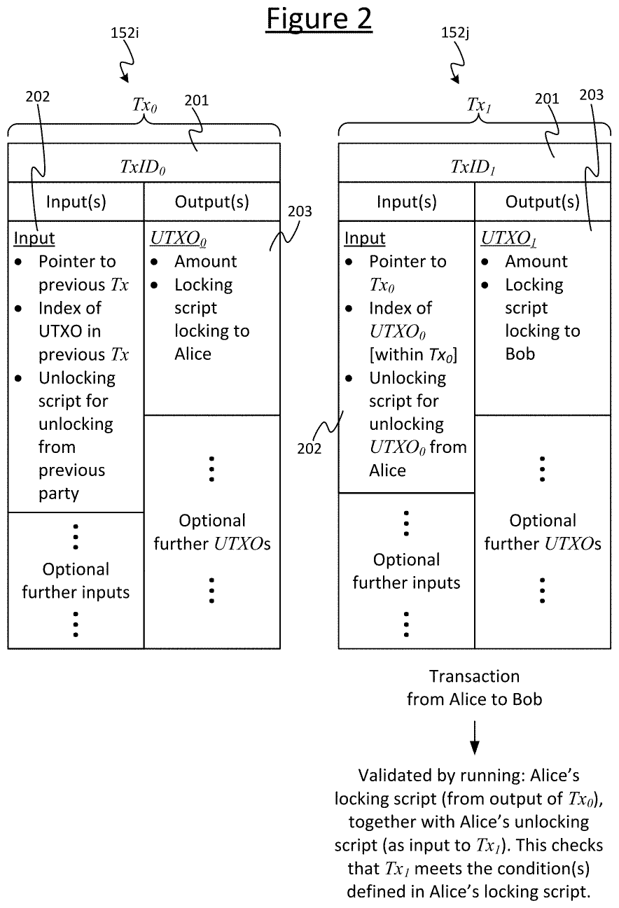

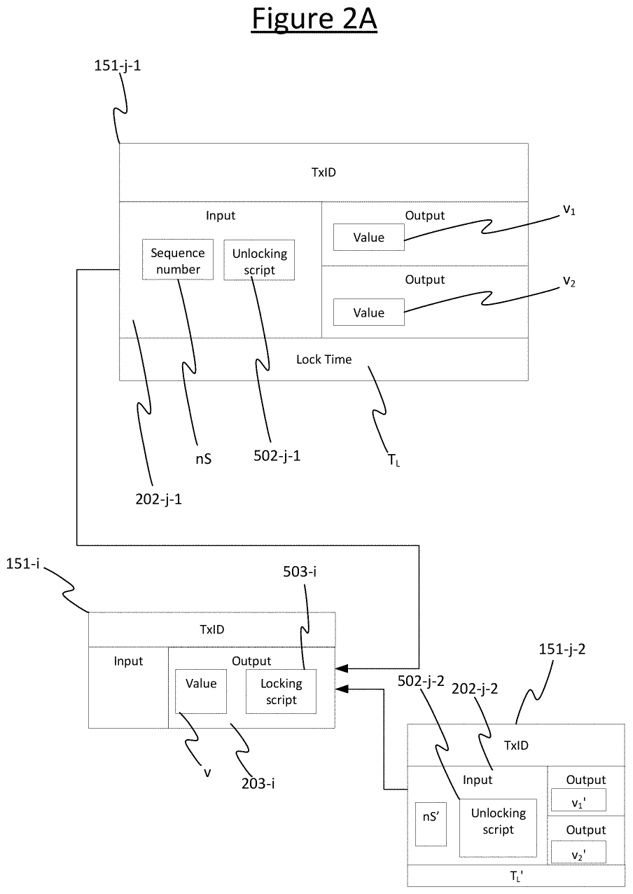

FIG. 2 illustrates an example transaction protocol. This is an example of an UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this not limiting to all possible embodiments.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO specifies an amount of a digital asset (a store of value). It may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the miners 104M.

Say Alice 103a wishes to create a transaction 152j transferring an amount of the digital asset in question to Bob 103b. In FIG. 2 Alice's new transaction 152j is labelled “Tx₁”. It takes an amount of the digital asset (digital asset value) that is locked to Alice in the output 203 of a preceding transaction 152i in the sequence, and transfers at least some of this to Bob. The preceding transaction 152i is labelled “Tx₀” in FIG. 2. Tx₀ and Tx₁ are just an arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in the blockchain 150 at the time when Alice creates her new transaction Tx₁, or at least by the time she sends it to the network 106. It may already have been included in one of the blocks 151 at that time, or it may be still waiting in the pool 154 in which case it will soon be included in a new block 151. Alternatively Tx₀ and Tx₁ could be created and sent to the network 102 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given node 104. Nevertheless, a subsequent transaction (the descendent transaction or “child”) which points to a preceding transaction (the antecedent transaction or “parent”) will not be validated until and unless the parent transaction is validated. A child that arrives at a node 104 before its parent is considered an orphan. It may be discarded or buffered for a certain time to wait for the parent, depending on the node protocol and/or miner behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S). The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). What data (or “message”) needs to be signed by Alice to provide a valid signature may be defined by the locking script, or by the node protocol, or by a combination of these.

When the new transaction Tx₁ arrives at a node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}> <P_{A}>∥[Checksig P_{A}]
where “∥” represents a concatenation and “< . . . >” means place the data on the stack, and “[ . . . ]” is a function comprised by the unlocking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the locking script in the input of Tx₁ contains the signature of Alice signing the expected portion of data. The expected portion of data itself (the “message”) also needs to be included in Tx₀ order to perform this authentication. In embodiments the signed data comprises the whole of Tx₀ (so a separate element does to need to be included specifying the signed portion of data in the clear, as it is already inherently present).

The details of authentication by public-private cryptography will be familiar to a person skilled in the art. Basically, if Alice has signed a message by encrypting it with her private key, then given Alice's public key and the message in the clear (the unencrypted message), another entity such as a node 104 is able to authenticate that the encrypted version of the message must have been signed by Alice. Signing typically comprises hashing the message, signing the hash, and tagging this onto the clear version of the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the node 104 deems Tx₁ valid. If it is a mining node 104M, this means it will add it to the pool of transactions 154 awaiting proof-of-work. If it is a forwarding node 104F, it will forward the transaction Tx₁ to one or more other nodes 104 in the network 106, so that it will be propagated throughout the network. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the node 104 also needs to check whether the referenced UTXO in the preceding transaction Tx₀ is already spent (has already formed a valid input to another valid transaction). This is one reason why it is important for the blockchain 150 to impose a defined order on the transactions 152. In practice a given node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor mined into blocks 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the winning miner, because nowadays the reward of the generation transaction alone is not typically sufficient to motivate mining. If Alice does not include a fee for the miner, Tx₀ will likely be rejected by the miner nodes 104M, and hence although technically valid, it will still not be propagated and included in the blockchain 150 (the miner protocol does not force miners 104M to accept transactions 152 if they don't want). In some protocols, the mining fee does not require its own separate output 203 (i.e. does not need a separate UTXO). Instead any different between the total amount pointed to by the input(s) 202 and the total amount of specified in the output(s) 203 of a given transaction 152 is automatically given to the winning miner 104. E.g. say a pointer to UTXO₀ is the only input to Tx₁, and Tx₁ has only one output UTXO₁. If the amount of the digital asset specified in UTXO₀ is greater than the amount specified in UTXO₁, then the difference automatically goes to the winning miner 104M. Alternatively or additionally however, it is not necessarily excluded that a miner fee could be specified explicitly in its own one of the UTXOs 203 of the transaction 152.

Alice and Bob's digital assets consist of the unspent UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the storage nodes 104S, e.g. the storage node 104S that is closest or best connected to the respective party's computer equipment 102.

Note that the script code is often represented schematically (i.e. not the exact language). For example, one may write [Checksig P_{A}] to mean [Checksig P_{A}]=OP_DUP OP_HASH160<H(P_{A})>OP_EQUALVERIFY OP_CHECKSIG. “OP_. . . . ” refers to a particular opcode of the Script language. OP_CHECKSIG (also called “Checksig”) is a Script opcode that takes two inputs (signature and public key) and verifies the signature's validity using the Elliptic Curve Digital Signature Algorithm (ECDSA). At runtime, any occurrences of signature (‘sig’) are removed from the script but additional requirements, such as a hash puzzle, remain in the transaction verified by the ‘sig’ input. As another example, OP_RETURN is an opcode of the Script language for creating an unspendable output of a transaction that can store metadata within the transaction, and thereby record the metadata immutably in the blockchain 150. E.g. the metadata could comprise a document which it is desired to store in the blockchain.

The signature P_{A} is a digital signature. In embodiments this is based on the ECDSA using the elliptic curve secp256k1. A digital signature signs a particular piece of data. In embodiments, for a given transaction the signature will sign part of the transaction input, and all or part of the transaction output. The particular parts of the outputs it signs depends on the SIGHASH flag. The SIGHASH flag is a 4-byte code included at the end of a signature to select which outputs are signed (and thus fixed at the time of signing).

The locking script is sometimes called “scriptPubKey” referring to the fact that it comprises the public key of the party to whom the respective transaction is locked. The unlocking script is sometimes called “scriptSig” referring to the fact that it supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Sequence Numbers and Lock Times

FIG. 2A shows a schematic illustration of a second transaction 152-j−1 that has a specific use in the context of a particular form of payment channel.

The second transaction 152-j−1 is shown to comprise at least one input 202-j−1. The input 202-j−1—in addition to containing a pointer to an output 203-i of a first transaction 151-i and an unlocking script 502-j−1 for unlocking that output 203-i, i.e. which meets (all of) the condition(s) specified in a locking script 503-i of that output 203-i—has a sequence number nS. The output 203-i of the first transaction 151-i contains a value denoted as v (digital asset value), which defines an amount of digital asset conveyed by the output 203-i. That same notation is used elsewhere in this description.

The second transaction 152-j−1 also has a defined lock time T_{L} and the second transaction 152-j−1 cannot be accepted as valid until its lock time T_{L} has expired. Assuming it meets all other requirements for validity, once the lock time T_{L} has expired, the second transaction 152-j−1 will only be accepted as valid if the blockchain network 101 has not received any other “conflicting” transaction which is valid and has a higher sequence number. Two transactions are said to “conflict” if they both have at least one input which spends the same output (more precisely, if they both have at least one input containing a pointer to the same output and a locking script which satisfies the one or more conditions defined in a locking script of that output, and both satisfy any other validity requirements—i.e. but for the presence of the transaction having the higher sequence number, the transaction with the lower sequence number would be accepted as valid).

By way of example, FIG. 2A shows a third transaction 151j−2 comprising at least one input 202-j−2 which contains a pointer to the same output 503-i of the first transaction 151-i and an unlocking script 502-j−2 which also satisfies all of the condition(s) specified in the locking script 503-i of that output 203-i. The third transaction 151-j−2 has a lock time T′_{L} (which may or may not be the same as the lock time T_{L} of the second transaction 152-j−1), and the input 202-j−2 of the third transaction 151-j−2 has a sequence number nS′. If both the second and third transactions 151-j−1, 151-j−2 are submitted to the blockchain network 101 after their respective lock times T_{L}, T′_{L} have expired, only the one with the highest sequence number will be accepted as valid (unless, of course, another conflicting transaction with even higher sequence number has been submitted).

In the present example, the second and third transactions 152-j−1, 152-j−2 are shown to each have at least two outputs, which in turn have digital asset values v₁ and v₂ respectively in the case of the second transaction 152-j−1, and digital asset values v′₁ and v′₂ respectively in the case of the third transaction 152-j−2. Although not depicted in FIG. 2A, each of those outputs will typically have its own unlocking script which must be satisfied in order to release the corresponding amount of digital asset. For example, the two outputs of each of the second and third transactions 151-j−1, 151-j−2 may have the effect of distributing the amount of digital asset conveyed by the output 203-i of the first transaction 152-i (as defined by v) between two different parties, where:
if the second transaction 151-j−1 is valid, the first party receives the amount of digital asset defined by v₁ and the second party receives the amount of digital asset defined by v₂; whereas
if the third transaction 151-j−2 is valid, the first party receives the amount of digital asset defined by v′₁ and the second party receives the amount of digital asset defined by v′₂.

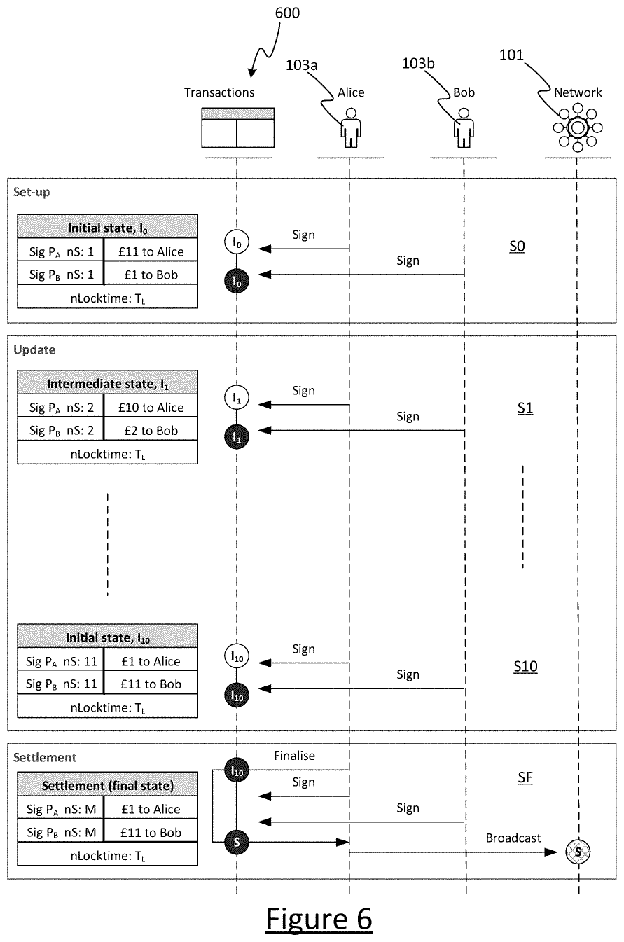

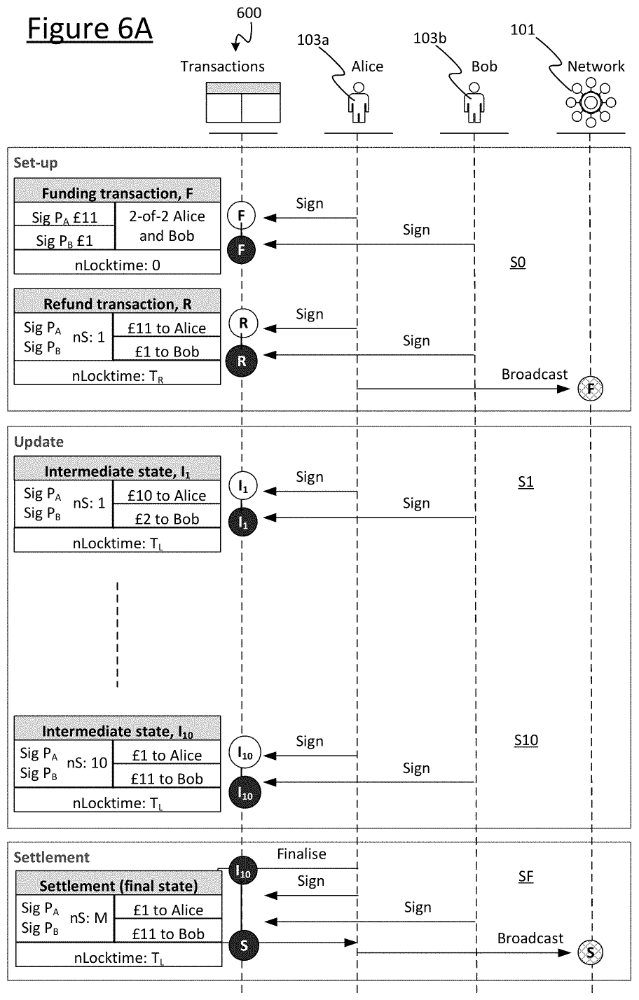

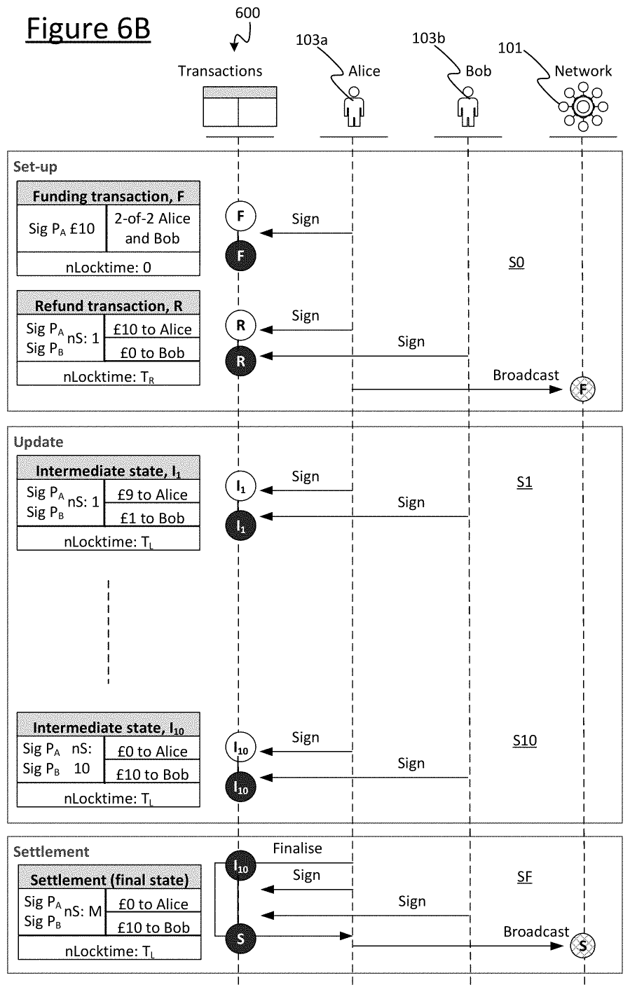

For example, the first transaction 151-i may be a special “funding transaction” having certain properties that are described later with reference, in particular, to FIGS. 6A and 6B. A payment channel can then be used as a basis for negotiating a distribution of digital asset conveyed by the funding transaction between two or more parties, by creating successive spending transactions, with future lock times and incrementing sequence numbers, which distribute that amount in different way (as defined by the digital asset values of the outputs of the spending transactions).

### Side Channel

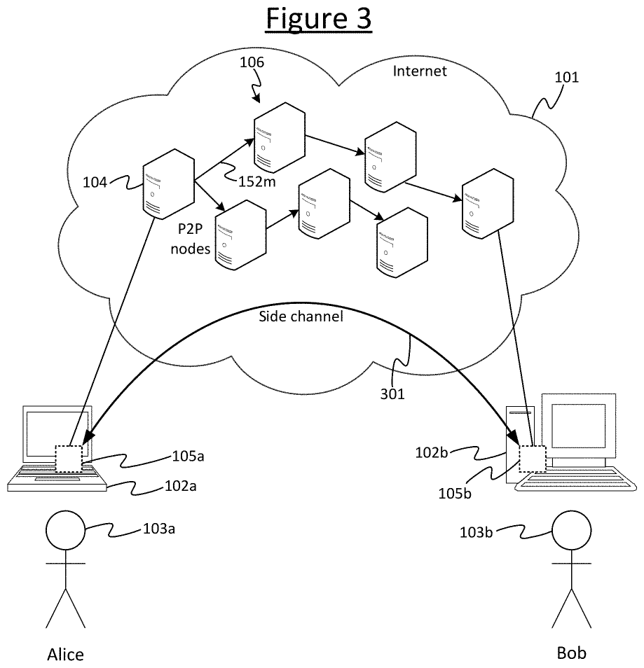

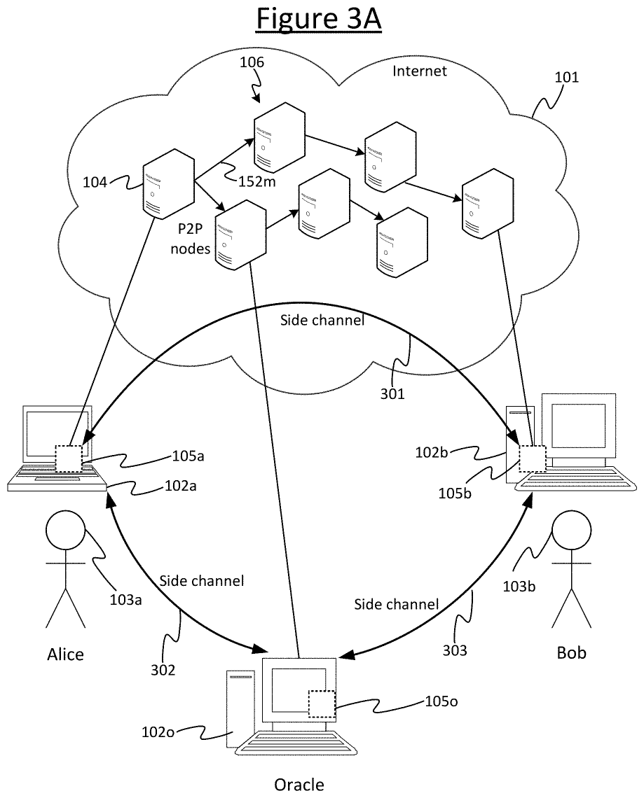

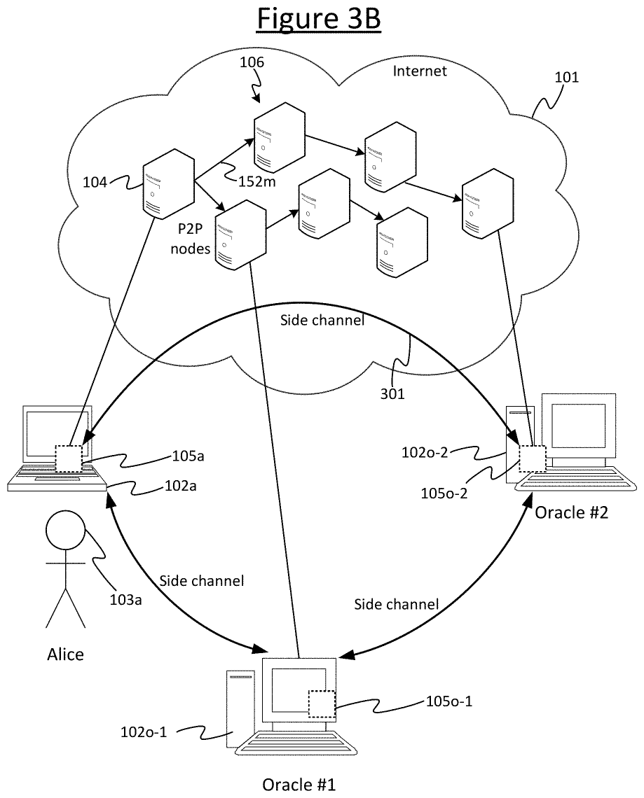

FIG. 3 shows a further system 100 for implementing a blockchain 150. The system 100 is substantially the same as that described in relation to FIG. 1 except that additional communication functionality is involved. The client application on each of Alice and Bob's computer equipment 102a, 120b, respectively, comprises additional communication functionality. That is, it enables Alice 103a to establish a separate side channel 301 with Bob 103b (at the instigation of either party or a third party). The side channel 301 enables exchange of data separately from the P2P network. Such communication is sometimes referred to as “off-chain”. For instance this may be used to exchange a transaction 152 between Alice and Bob without the transaction (yet) being published onto the network P2P 106 or making its way onto the chain 150, until one of the parties chooses to broadcast it to the network 106. Alternatively or additionally, the side channel 301 may be used to exchange any other transaction related data, such as keys, negotiated amounts or terms, data content, etc.

The side channel 301 may be established via the same packet-switched network 101 as the P2P overlay network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 301 as referred to anywhere herein may comprise any one or more links via one or more networking technologies or communication media for exchanging data “off-chain”, i.e. separately from the P2P overlay network 106. Where more than one link is used, then the bundle or collection of off-chain links as a whole may be referred to as the side channel 301. Note therefore that if it is said that Alice and Bob exchange certain pieces of information or data, or such like, over the side channel 301, then this does not necessarily imply all these pieces of data have to be send over exactly the same link or even the same type of network.

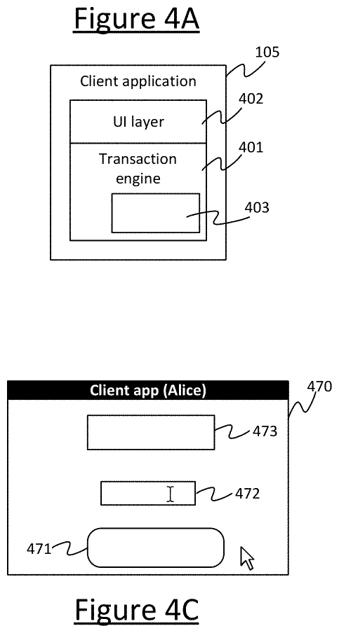

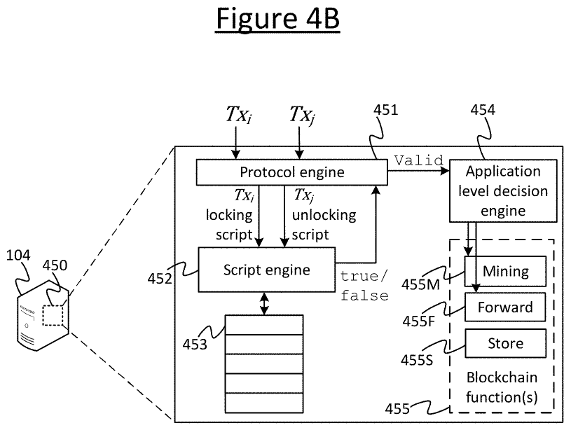

FIG. 3A shows a variation of the system of FIG. 3 with at least three parties, one of which/whom is a “trusted oracle” 102o. In this example, the trusted oracle takes the form of a set of oracle computer equipment 102o running client software 105o—of the kind described above and in further detail below with reference to FIG. 4—that operates autonomously to carry out the functions described below (without any substantive human oversight). Alternatively, the trusted oracle may be a human user operating similar computer equipment 102o, in which case those functions are carries out at the oracle computer equipment 102o with at least an element of human oversight and/or control. Respective side channels between each pair of parties are provided, denoted by reference numerals 301 (between Alice 103a and Bob 103b), 302 (between Alice 103a and the oracle 102o) and 303 (Between Bob 103b and the oracle 102o).

FIG. 3B shows a further variation, again with at least three parties, but in this case at least two of the parties are trusted oracles 102o−1, 102o−2. In this particular example, the second trusted oracle 102o−2 essentially assumes Bob's role, and all of the above description pertaining to Bob 103a and his computer equipment 102b applies equally to the second oracle 102o−1.

The role of a trusted oracle (or oracles) in the context of a blockchain payment channel is described in detail below with reference to particular examples.

### Client Software

FIG. 4A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to be propagated through the P2P network 106, in accordance with the schemes discussed above and as discussed in further detail shortly. In accordance with embodiments disclosed herein, the transaction engine 401 of the client 105 of at least one party to a payment channel (who/which may or may not be a trusted oracle) comprises payment channel logic 403 for generating and signing payment channel transactions which can be sent to another party or parties for completion as needed, or completed as needed by the same party using information received from another party or parties. This is described in detail later.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

The presence of the UI layer 402 assumes the computer equipment 102 is to be operated by a user. Certain parties to a payment channel may in fact be autonomous machine entities, i.e. computer equipment that operates to generate and sign transactions without any (or with minimal) human oversight. In particular, the payment channel logic 203 may operate with or without human oversight. This applies both to parties who/which are trusted oracles any and party to a payment channel who/which is a not a trusted oracle. With regards to the former, although in the above examples Alice 103a and Bob 103b are presented as human users by way of examples, one or both of their roles could be assumed by an autonomous machine(s) (which is to say that one or both of Alice's or Bob's computer equipment 105a, 105b could operate autonomously or substantially autonomously).

FIG. 4C gives a mock-up of an example of the user interface (UI) 470 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 4C shows the UI 470 from Alice's perspective. The UI 470 may comprise one or more UI elements 471, 472, 472 rendered as distinct UI elements via the user output means.

For example, the UI elements may comprise one or more user-selectable elements 471 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to e.g. display and, where appropriate, sign existing (but perhaps incomplete) payment channel transaction, or in some cases create new payment channel transactions. Alternatively or additionally, the UI elements may comprise one or more data entry fields 472, through which the user perform such operation. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 453 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 470 shown in FIG. 4C is only a schematized mock-up and in practice it may comprise one or more further UI elements, which for conciseness are not illustrated.

### Node Software

FIG. 4B illustrates an example of the node software 450 that is run on each node 104 of the P2P network 106, in the example of a UTXO- or output-based model. The node software 450 comprises a protocol engine 451, a script engine 452, a stack 453, an application-level decision engine 454, and a set of one or more blockchain-related functional modules 455. At any given node 104, these may include any one, two or all three of: a mining module 455M, a forwarding module 455F and a storing module 455S (depending on the role or roles of the node). The protocol engine 401 is configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. It may retrieve Txᵢ from the respective node's own pool 154 of pending transactions if Txᵢ is not already on the blockchain 150, or from a copy of a block 151 in the blockchain 150 stored at the respective node or another node 104 if Txᵢ is already on the blockchain 150. Either way, the script engine 451 identifies the locking script in the pointed-to output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control one or both of the mining module 455M and the forwarding module 455F to perform their respective blockchain-related function in respect of Txⱼ. This may comprise the mining module 455M adding Txⱼ to the node's respective pool 154 for mining into a block 151, and/or the forwarding module 455F forwarding Txⱼ to another node 104 in the P2P network 106. Note however that in embodiments, while the decision engine 454 will not select to forward or mine an invalid transaction, this does not necessarily mean that, conversely, it is obliged to trigger the mining or the forwarding of a valid transaction simply because it is valid. Optionally, in embodiments the application-level decision engine 454 may apply one or more additional conditions before triggering either or both of these functions. E.g. if the node is a mining node 104M, the decision engine may only select to mine the transaction on condition that the transaction is both valid and leaves enough of a mining fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model (not illustrated in FIG. 4), a result of “true” could be indicated by a combination of an implicit, protocol-level) validation of a signature by the node 104 and an additional affirmative output of a smart contract (the overall result being deemed to signal true if both individual outcomes are true).

### 2. Blockchain Payment Channels

A payment channel allows users and/or autonomous entities (machines) to communicate peer to peer via transactions. It serves not only as a communication channel but may also serve as a negotiation and settlement process. When designing a payment channel, an important aspect is the balance between security and efficiency.

A number of general payment channel designs are described below, in order to provide relevant context to the described embodiments of the present technology.

In brief, the described embodiments utilize what is referred to herein as a “funded Nakamoto payment channel”, which provides the security that all participants can be assured of not being cheated by others.

Additional “application-layer” rule(s) can be imposed on a payment channel (in addition to any “native” rules of the blockchain protocol that are used to determine transaction validity). Such application-layer rules can be enforced using one or more of the payment channel methodologies taught herein.

### 2.1 Preliminaries

### 2.1.1 Blockchain Script

Briefly recapping the more detailed description above, a blockchain 150 comprises blocks 151 of transactions 152, whereby each transaction 152 may encode a transfer of digital asset from one address to another using a stack-based scripting language known referred to herein generally as Script (capital S).

Transactions contain scripts written in this language (Script-code), which can appear in one or both of their inputs 202 and outputs 203. Output scripts typically have the function of locking an amount of digital asset by placing a spending condition(s) on it, while input scripts have the function of unlocking such an amount of digital asset by satisfying such spending conditions. Input and output scripts are thus referred to as unlocking scripts and locking scripts respectively herein.

Note that the terms scriptSig′ and scriptPubKey′ may sometimes be used instead of the terms unlocking script and locking script respectively. Such terminology assumes that an amount of digital asset it locked to at least one public key, and thus requires at least one transaction signature to unlock. This is often true in practice, but it is not a requirement of output-based protocols—any locking script can be defined, which may or may not require a valid transaction signature to unlock. It will therefore be appreciated that all description pertaining to scriptSig′ and scriptPubKey′ applies equally to any form of locking/unlocking script, unless context demands otherwise.

### Script Execution

In order to validate transactions, script execution is performed by at least some nodes 104 of the blockchain network 101. This ensures that the unlocking script, used by a transaction 152 input to spend an amount of digital asset, does indeed satisfy the spending condition(s) defined by the locking script of the previous (source) transaction conveying that amount of digital asset. This is illustrated in FIG. 2 and described in detail above.

The amount of digital asset conveyed by a transaction 152 with a single output 203 is defined by the digital asset value of the single output. The amount of digital asset conveyed by a transaction 152 with multiple outputs 203 is defined by the digital asset values of those multiple outputs.

Note the term ‘digital asset unit’ herein means an amount v of bitcoins, locked by a locking script in an output of a given transaction Tx with identifier TxID.

The process of script execution is responsible for ensuring that an unlocking script satisfies a locking script in order to create a successful spending relationship such as the one shown in FIG. 2. This process can be summarised as follows:
1. Execute the unlocking script with a new stack 453.
2. Keep the stack 453 as it is at the end of execution in (1).
3. Execute the locking script using the stack 453 from (2).
4. If the top stack item after (3) is non-zero and non-empty, the spending is valid.

The process above describes exactly how script execution is actually implemented by a node 104 validating a transaction 152. However, the process can be conceptually understood by interpreting script execution as:
1. Put the unlocking and locking scripts together as:
   [Unlocking script] OP_CODESEPARATOR [Locking script]
2. Executing the resulting scripts from (1), from left to right, using a common stack.
3. If the top stack item after (2) is non-zero and non-empty, the spending is valid.

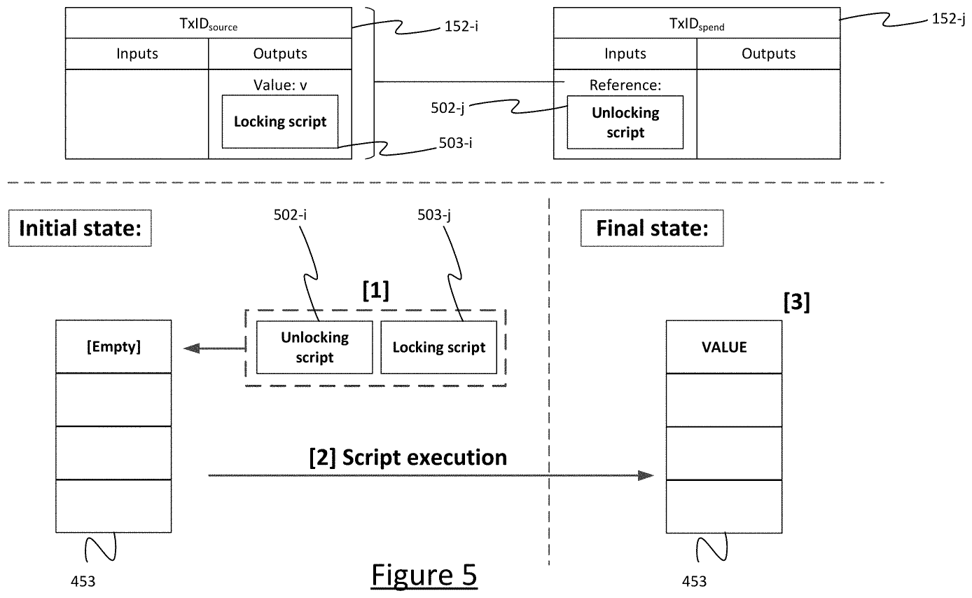

FIG. 5 shows a high-level overview of this conceptual interpretation of the process of script execution, in which unlocking script in an output of a first transaction 152-i and locking script in an input of a second transition 152-j are denoted by reference numerals 503-i and 502-j respectively. Steps 1 to 3 immediately above are denoted by corresponding numbers in square brackets. As indicated, the input of the second transaction 152-j has a pointer to the output of the first transaction 152-i (in the form of a point to the second transaction 152-j together with an index of the output of the first transaction 152-i—see FIG. 2 above).

### 2.2 Payment Channels

The term payment channel is taken generally to mean a communication channel (side channel, such as one of the side channels 301, 302 and 303 described above), established between multiple parties in a peer-to-peer fashion, whereby messages exchanged via the communications channel take the form of transactions 152. In a payment channel, it may the case that not all of these transactions are committed to the blockchain 152, and they may not even be published (in the above-defined sense). Indeed, in practice, it may be the case that only a small number of these transaction messages are actually published, in order to represent the settlement (and optionally the instigation) of such a channel (but not necessarily all of the intermediate negotiation steps that led to settlement).

A number of scenarios, including peer-to-peer interactions such as micropayments, may involve a number of potentially high-frequency transactions that do not all need to be published.

There are many variants of the general concept of payment channels. This description will focus only on two payment channel architectures in particular:

Nakamoto payment channels—based on nSequence and nLocktime.

Funded Nakamoto (FN) payment channels—a Nakamoto architecture with funding. Despite their differences, all of these payment channel architectures can be described as three phase processes, which underpin payment channels as a concept. These phases are:
1. Set-up phase—the initialisation of a payment channel;
2. Negotiation phase—creation of off-chain intermediate states; and
3. Settlement phase—the closure of a payment channel.

This description first considers the case of two parties (such as Alice and Bob) who wish to transact many times yet only publish the initial and/or final states of the interaction on-chain.

### Directionality

Before detailing different example payment channel architectures, certain terms related to the directionality of payment channels are defined:

Bidirectional—a payment channel in which the initial state of funds includes contributions from both parties is said to be bidirectional. This means that, overall, the payment channel may induce a net payment to either party.

Unidirectional—a payment channel, conducted between exactly two parties, in which the initial state of funds includes contributions from only one party (a payer) is said to be unidirectional. This means that, overall, the payment channel may induce a net payment to the second party (payee) i.e. the party who does not contribute funds to the initial state of the channel.

The distinction between a net payment and a state transition is noted. In both bidirectional and unidirectional payment channels, an intermediate state transition may reallocate funds toward either party (i.e. in either direction). However, the direction of any possible net change in a payment channel is defined by which parties contribute funds to the initial state.

### 2.1.1 Nakamoto Payment Channels

A Nakamoto payment channel architecture is set out in the following document, incorporated herein by reference in its entirety: S. Nakamoto and M. Hearn, [Bitcoin-development] Anti DoS for tx replacement, Lists.linuxfoundation.org, 2019.

Such a payment channel utilized sequence numbers and lock times (see FIG. 2A) in the following manner.

The architecture is based on the fact that a transaction, having a “non-final” nSequence number(s) in its input(s), can be updated many times before it becomes valid at nLocktime.

The following assumes, for simplicity, a payment channel between two parties for simplicity. However, payment channels with more than two participants are viable, and various examples of such payment channels are described later.

The outline of a simple Nakamoto payment channel between two such parties can be viewed as a simple three-phase process as follows.
1. Set-up phase:
   Alice and Bob each contribute and sign an input to create an initial version of a transaction between them. This initial version represents the initial state of the payment channel, and is kept off-chain. This transaction is time-locked, meaning it has a non-zero nLocktime value set to a suitable point T_{L} in the future.
2. Update phase:
   Alice and Bob update the state of the payment channel by signing a new version of the initial transaction, with higher sequence numbers on both their inputs (transaction replacement), and having updated the transaction details to reflect the desired new state of payment.
   This process is repeated, creating new intermediate states, as many times as required before nLocktime is reached. Each time a new version is signed with a higher sequence number, all versions with a lower sequence number are invalidated.
3. Settlement phase:
   Alice and Bob can settle the payment channel by either:
      (i) publishing the version of the transaction with highest nSequence number once nLocktime T_{L} has elapsed; or
      (ii) finalising the transaction prior to nLocktime by mutually signing with the maximum value sequence number (nSequence=0xFFFFFFFF).

Note that there is no requirement for any initial transaction to be published, and only the very final state needs to be published and mined onto the blockchain. However, there exists a possible security vulnerability whereby either party's input could be ‘double-spent’ at any time before settlement, because no transaction is published prior to the time of settlement.

A Nakamoto payment channel can be implemented in either the bidirectional or unidirectional configurations, simply by changing who has contributed to the initial state.

FIG. 6 shows an example process diagram for a Nakamoto payment channel architecture.

The process diagram illustrates a typical Nakamoto payment channel, in the bidirectional configuration, according to this description. The notation ‘nS’ is used as shorthand for nSequence, ‘M’ denotes the maximum e.g. 4-byte value (0xFFFFFFFF) a sequence number nS can take, ‘Iₙ’ denotes a state n (I₀ being an initial state) and ‘S’ denotes a settlement transaction. White circles represent incomplete transactions, whilst black circles represent complete transactions, and cross-hatched circles for transactions that have been successfully mined. In this context, the term “state” refers to a partial or completed spending transaction which has not necessarily been mined or published.

The reference numeral 600 is used to denote a series of spending transaction created, over time, via a payment channel. The payment channel is implemented in a sequence of steps, with Sn denoting the step in which state Iₙ is created (S0 being an initial step in which the initial state I₀ is established). A final step SF creates the settlement transaction S, and this step SF may or may not occur, depending on whether all parties remain cooperative through the entire negotiation.

### 2.2.2 Funded Nakamoto (FN) Payment Channels

A “funded” payment channel refers to a situation in which a special funding transaction is committed to the blockchain 150 before the negotiation commences. One example of a funded payment channel is a Spilman payment channel, which does not make use of sequence numbers of lock times.

Both Nakamoto channels and Spilman channels have different features and properties, as well as different security vulnerabilities dependant on the situational requirements of the channel. The security flaws in particular are summarised as:

Nakamoto—because there is no funding transaction, it is possible for either party to maliciously double-spend their money at any point prior to settlement.

Funded (Spilman)—because there is no use of nSequence and nLocktime in the update phase, it is possible for one party to maliciously broadcast an early state if implemented poorly.

This section introduces the concept of a Funded Nakamoto (FN) payment channel to show how both of these security flaws can be mitigated.

The term ‘Funded Nakamoto payment channels’ is used to describe any payment channel that both:
Uses transaction replacement in the update phase, by employing nLocktime and incrementing nSequence, analogous to a Nakamoto payment channel (2.2.1); and
Uses a funding transaction to “escrow” the interacting parties' funds, and record the initial state of the payment channel on-chain.

An example three-phase outline of an FN payment channel, in the bidirectional configuration, is provided as follows:
1. Set-up phase:
   Alice and Bob collaborate to create a funding transaction, which escrows funds jointly to a 2-of-2 multisignature address. This defines the initial state of their funds and it must be published on-chain.
   Alice and Bob collaborate to create a refund transaction, which returns the escrowed funds to the original owners according to the initial state. This transaction is time-locked, meaning it has a non-zero nLocktime value set to a suitable point T_{R} in the future.
2. Update phase:
   Alice and Bob collaborate, by providing their respective signatures, to create a transaction spending the output of the funding transaction. This is the first intermediate state of the payment channel, and reflects an initial payment direction. This intermediate state is time-locked to a suitable time T_{L} in the future, such that T_{L}≤T_{R}.
   Alice and Bob update the state of the payment channel by signing a new version of the initial state transaction, with a higher sequence number (transaction replacement), and having updated the transaction details to reflect the desired new state of payment. The nLocktime of each new state remains consistently at the value T_{L}.
   This process is repeated, creating new intermediate states, as many times as required before intermediate transaction nLocktime T_{L} elapses.
3. Settlement phase:
   Alice and Bob can settle the payment channel by either:
      (i) publishing the version of the transaction with highest nSequence number once nLocktime T_{L} has elapsed; or
      (ii) finalising the transaction prior to nLocktime T_{L} by mutually signing with the maximum value sequence number (nSequence=0xFFFFFFFF).
   In either case, the final state is published and mined into the blockchain 150.

The notation T_{R} and T_{L} is used to distinguish between the nLocktime limits placed on the refund transaction and the intermediate transaction version(s) respectively. These times may be different because the time T_{L} at which negotiation of the intermediate states must cease may be different than the time T_{R} at which the parties wish to be mutually refunded if the interaction or negotiation fails. The relationship between them should be T_{L}≤T_{R} to ensure that negotiation would cease before either party is able to be refunded. It would cause an issue if it were possible for a party to be refunded during the update phase.

FIGS. 6A and 6B illustrate two examples of Funded Nakamoto payment channels, in the bidirectional and unidirectional configurations respectively.

In both cases, it can be seen that a special funding transaction F is created and signed by the parties in the initial step S0, and committed to the blockchain 150 before proceeding (as denoted by the cross-hatched circled to the right-hand side of the figure in the section representing step S0).

Typically, the finding transaction F will have an output that requires at least two valid transaction signatures, from different parties, to unlock (there may or may not be additional requirement(s)). In the simplest case, it simply requires signature from Alice and Bob, however extensions are described later which use more complex multi-signature locking conditions, such as an “m-of-n multi-signature requirement” (see below).

The transaction which does eventually unlock the output of the funding transaction F will—if all goes to plan—be the settlement transaction S, as is depicted in all of FIGS. 6, 6A and 6B. However, in the event that the negotiation terminates before any settlement transaction S is completed, any party can publish whichever completed transaction Iₙ of the series of spending transactions 600 has the highest sequence number—and that transaction will unlock the output of the funding transaction F. The transaction which unlocks the output of the funding transaction F has the effect of distributing the value v of the output of the funding transaction between the parties (or a subset of the parties).

This description has already outlined above—with reference to FIG. 2A—how a series of spending transactions can be created over time to negotiate a distribution of an amount of digital asset between two or more parties.

In the example of FIG. 6A, each party commits an amount of digital asset to the spending transaction—£11 and £1 from Alice and Bob respectively (where “£” denotes whatever unit issued to quantify digital asset according to the blockchain protocol in question; elsewhere the letters “BSV” may be used to denote units of digital asset). These amounts are committed by way of two signed inputs in the funding transaction F—one which validly spends £11 belonging to Alice (requiring a valid transaction signature from Alice), and the other of which validly spends £1 belonging to Bob (requiring a valid transaction signature from Bob). The refund transaction R has two outputs, which restore the status quo—i.e., were the refund transaction R to be mined, it would convey £11 back to Alice and £1 back to Bob (any mining fees are ignored for the sake of simplicity). The payment channel is then used to negotiate incremental increases in Bob's share, offset against corresponding decreases in Alice's.

In FIG. 6B, the principles are the same, but in this case only Alice commits any digital asset initially in the funding transaction F, and the refund transaction R would transfer all of this back to Alice. Successive spending transactions incrementally increase the amount to be paid to Bob, offset against any amount paid back to Alice.

### 3. Payment Channel Loops

It is possible to use payment channels to implement loops, and that this can be achieved in a number of ways. This disclosure refers to loops implemented by use of a payment channel as Payment Channel Loops (PCLs).

The execution of such looping functionality, when implemented using a payment channel, will generally require some form of off-chain processing. This refers to any type of processing which may involve one or many of:
(i) reading transactions;
(ii) writing transactions;
(iii) using an off-chain instance of the scripting engine 452 to pieces of Script; and
(iv) using an alternative engine to execute code of an alternative language (“non-Script” herein).

The ultimate goal of implementing a PCL is to allow an iterative process to be performed off-chain, while ensuring that the funds associated with the channel are distributed between participants correctly. This means that the funds should be dependent on the outcome(s) of the process and in accordance with any rules of the channel. The final and/or initial state of the process may also be recorded on chain.

The term “off-chain” refers to processing that is not performed as part of the transaction validation process, i.e. which is performed outside of the blockchain protocol. Typically, this would occur at an external system which is not part of the blockchain network 101, but which may have access to the blockchain network 101 and thus have visibility of published transactions. This would include, for example, processing by Alice, Bob or any of the trusted oracles 150o, 150o−1, 150o−2 mentioned above.

In some respects, payment channel loops match, and in certain ways exceed the benefits associated with account-based blockchains. An account-based blockchain with a Turing-complete virtual machine can execute program loops “on-chain” as part of transaction validation. On the one hand this is beneficial, but on the other hand it is costly in terms of computational resources. A smart contract may be called multiple times by multiple later transactions, and each time it is called, all nodes in the network that validate transactions will execute the smart contract code to validate the later transaction.

A limitation of certain script-based UTXO blockchains is the inability to execute loops on-chain. PLCs are a therefore highly effective mechanism for augmenting the native blockchain functionality of such blockchains, by providing a structured framework in which the execution of loops can be performed off-chain according to defined rules, with all parties being incentivized to behave in compliance with those rules, and with robust controls in the event any party fails to do so. A benefit of off-chain loop execution in this context is that it does not burden the entire network with needing to execute the loop, which means a significant saving in terms of computational resources.

The following examples are covered in the following sections of the description:
Mapping loops to payment channel architectures generally;
Bidirectional PCLs; and
Unidirectional PCLs.

The distinction is made between bidirectional and unidirectional PCLs because they may lend themselves to different use cases. For example, bidirectional PCLs may be used to implement the iteration of a process where a payment is to be rebalanced in either direction via state transitions, while unidirectional PCLs may be more suited to a ‘paid computation’ scenario whereby Alice pays Bob incrementally (i.e. per operation) for his computational resources.

### 3.1 Generic PCL Architecture

This section describes how the primary features of loops can be mapped to the features of general payment channel architectures (see 2.2).

### 3.1.1. Mapping Loops to Payment Channels

### The Loop

In general, any type of loop may be implemented in a payment channel. This description focusses mainly on a ‘for’ for demonstrative purposes.

A schematic version of a generic ‘for’ loop mapped to a payment channel is as follows:

```
V = Vᵢₙᵢₜᵢₐₗ
for (i = 0; i ≤ M; i++ ) {
            Vᵢ = Function ( V )
            V = Vᵢ
            }
```

The loop has elements which include a loop counter i, a starting point (0) and upper limit (M) for the counter, an initial value(s) passed to the loop Vᵢ and a repeating unit of code Function( ) (or just F( ) as a shorthand) that is to be executed on each iteration of the loop. An aim is to map elements of the loop to a PLC.

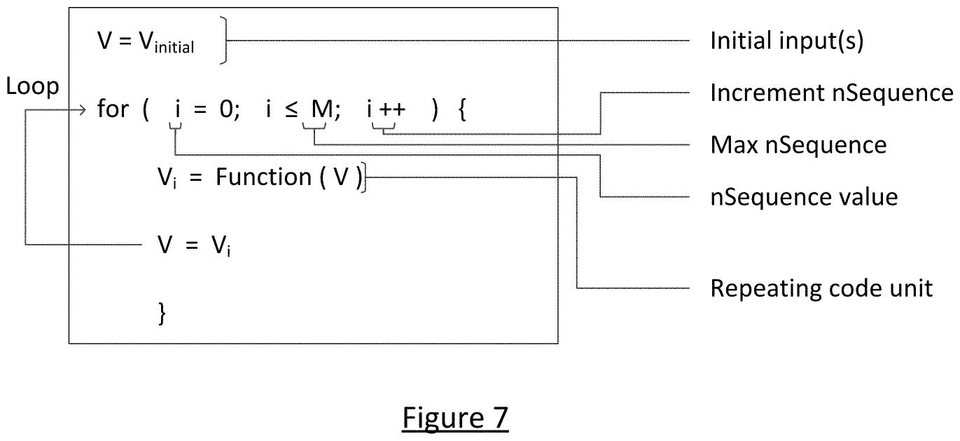

FIG. 7 illustrates a possible mapping of the elements of the ‘for’ loop to a payment channel. A description of this mapping follows.

Incrementing nSequence

The loop iteration counter i can, for example, be replaced in a PCL with the value of nSequence (or nS as shorthand) used in the input of transactions in the update phase.

The range of possible values for nSequence is between 0 and M, where M is the maximum nSequence value, which is considered ‘final’ by the blockchain protocol. In certain blockchain protocols, the largest 8-byte value, 0xFFFFFFFF, is taken to mean that a transaction is finalised, which means therefore that upper limit for the loop would be M=0xFFFFFFFF in that event. That is just under 4.3 billion when expressed as a decimal.

Mapping the loop counter i to the sequence number nS allows for just under 4.3 billion iterations of the loop to update a transaction, meaning the statement(s) in the body can be executed at least 4.3 billion times before the transaction is finalised.

Note the value of nS can be incremented in non-uniform steps of any size, despite the fact that the loop counter i increases uniformly in steps of one. This is because the only constraint on nS for the payment channel to function is that it increases in each step, which means a one-to-one map can be created between the values of i and the values of nS for any loop.

It is noted, however, that this example ties the value of nSequence to the counter of a ‘for’ loop purely for ease of demonstration. As indicated above, it is possible to map any form of loop to a set of transactions in a payment channel. This can be done by choosing any condition on which the loop repeats, such as ‘while (it is raining in June)’ or ‘for each (game won by Liverpool FC)’, to be verified off-chain, and ensuring what the value nSequence increments while that condition is true.

Methods for verifying such conditional statements for veracity can be implemented using oracle-based systems (see section 4).

### Inputs and Parameters

The ‘initial input’ passed to the loop has been referred to as V_{Initial}, where the letter V is used to mean ‘value’. However, more generally it is possible that the loop will depend on a number of different inputs and parameters, defined as follows:
Inputs ϕᵢ—values passed to the loop that may be updated by the loop on each iteration. Note the input to a function F( ) is distinct from an input 203 of a transaction 152; it will be clear in context which is meant. The term “input value” may be used to refer to the input as a function, and the term “transaction input” may be used to explicitly disguise between the two where helpful; and
Parameters ωᵢ—values passed to the loop that may be updated externally to the loop on each iteration.

Both input values and parameters are examples of “function variables” as the latter term is used herein. The terms “function variable” and “argument” may be used synonymously.

A set of inputs and parameters taken by the i^{th} iteration of the loop may be written as a tuple of arguments Vᵢ:=(ϕᵢ, ωᵢ), where the i^{th} sets of inputs and parameters are denoted as ϕᵢ and ωᵢ respectively.

In most cases, it is expected that at least some of the elements in Vᵢ, taken by the i^{th} transaction as arguments, will be encoded or represented in some way in the (i−1)^{th} transaction. In other words. It is expected that the i^{th} transaction will depend on the (i−1)^{th} transaction, whereby the dependency is defined by the repeating function F( ) of the loop.

Note that the input arguments (ϕᵢ, ωᵢ) may reside in any field of a transaction. Given that the input scripts of a transaction are not signed, it may be desirable for the arguments (ϕᵢ, ωᵢ) to reside in an output, which is signed, whether or not it is an unspendable (OP_RETURN) or spendable output (in a locking script).

For certain blockchain protocols, the code OP_RETURN should be taken to mean the pair of opcodes OP_0 OP_RETURN. This has the effect of safely restoring the functionality of OP_RETURN for any such protocol where that is necessary. For further details, see S. Shadders, “The return of OP_RETURN—roadmap to Genesis part 4—BitcoinSV”, BitcoinSV, 2019.

### 3.1.2 Repeating Functional Unit F( )

The term repeating functional unit refers to the main body of the loop to be implemented via a PCL, which is the portion of code comprising executable statements. In the present example, this is a functional unit of code denoted by F( ) above.

In terms of the architecture of a PCL, the repeating functional unit F( ) is the portion of code that will be executed off-chain in each iteration of the loop. The functional unit F( ) can be treated as a “black box”, which receives one or more arguments (input(s) and/or parameter(s)) and returns an output as the next input. Therefore, the input can be derived from the previous transaction, and the output can be used to form the next transaction.

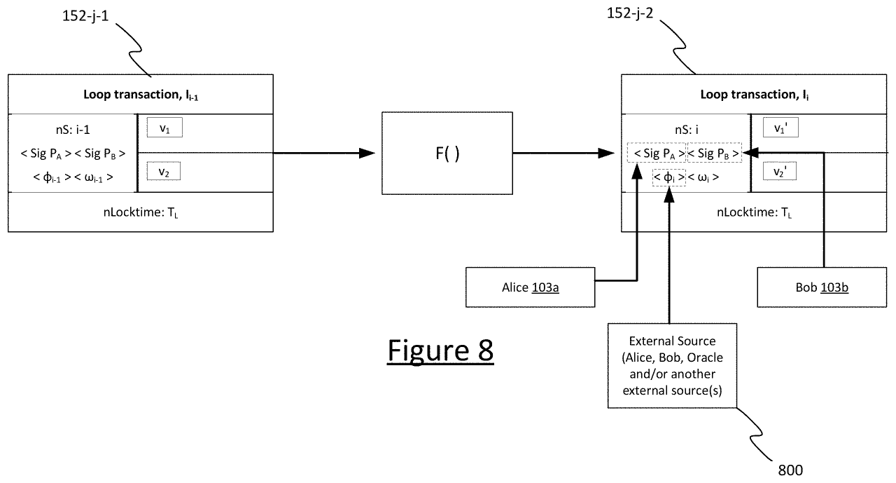

By way of example, FIG. 8 shows the functional unit F( ) taking a second transaction 152-j−1 as an ‘argument’ and yielding one or more components of a third transaction 152-j−2 as ‘output(s)’. Using the mathematical notation above, those transactions are denoted as Iᵢ₋₁ and Iᵢ respectively.

This could, for example, be the way in which the third transaction 152-j−2 of FIG. 2A is created. Although not depicted in FIG. 8, each of the second and third transactions 152-j−1, 152-j−2 would spend an output of the same first transaction 152-i as depicted in FIG. 2A.

FIG. 8 highlights certain the differences between the input transaction and the output transaction by: (i) incrementing the value of nSequence i−1→i; and (ii) updating the inputs and parameters (ϕᵢ₋₁, ωᵢ₋₁)→(ϕᵢ, ωᵢ), where (ϕᵢ₋₁, ωᵢ₋₁) represent the function variables in the second transaction 152-j−1 and (ϕᵢ, ωᵢ) represent the function variables in the third transaction 152-j−2.

Sig P_{A} and Sig PB denote valid transaction signatures provided by Alice and Bob respectively; the input value(s) ϕᵢ are by definition computed by executing the function F( ), i.e. as (or as part of) F(ϕᵢ, ωᵢ) (that is, the function F( ) applied to the function variables (ϕᵢ, ωᵢ) of the second transaction 152-j−1); the parameter(s) ωᵢ are by definition not computed in the execution of F( ) but rather are provided by one or more external sources 800 (i.e. external to the loop—not necessarily external to the device/system/equipment at which F is applied; for example, the external source(s) could be Alice, Bob, an Oracle 102o (or one or both of the Oracles 102o−1, 102o−2), and/or any other external source(s)).

In the present example, each transaction 152-j−1, 152-j−2 has two transaction outputs as in FIG. 2A—having digital asset values v₁, v₂ and v′₁, v′₂ respectively. The function F( ) may also determine the value(s) v′₁, v′₂ of the output of the returned transaction 152-j−2, and may use the digital asset values v₁, v₂ of the outputs of the input transaction 142-j−1 may in that case be used to determine v′₁, v′₂, in addition to (ϕᵢ₋₁, ωᵢ₋₁). Although in this example, each transaction has two outputs, that is not required in general; each transaction can have any number of outputs including one, and may or may not have the same number of outputs as each other.

The next section details how the functional unit F( ) an is executed repeatedly in a PCL, at least once per iteration of the loop. The reason for saying ‘at least’ once is because of the possibility that one iteration of the loop requires some integer k≥1 application of the unit.

There is choice between two options when expressing the function F( ) used in a PCL; it may be written in either Script (i.e. the scripting language of the blockchain 150) or some alternative language (non-Script). The choice made here may affect how the PCL is implemented:
Script—in this case the functional unit can exist as part of a spendable output script, which can be executed, using the Bitcoin script engine, off-chain by an interpreter alongside the arguments (ϕᵢ₋₁, ωᵢ₋₁) to produce one or more components of the next transaction.
Alternative non-Script language—in this case the functional unit may need to exist as part of an unspendable (e.g. OP_RETURN) output. The code unit F( ) can then be executed off-chain using some other engine, also using the arguments (ϕᵢ₋₁, ωᵢ₋₁) to produce one or more components of the next transaction.

Example PCL implementations are described in detail later, which demonstrate how both of these approaches may be useful in different circumstances.

It is important to note that, even in the case that the functional unit F is embodied as Script in a transaction, in the described examples, the validity of the transaction can be such that it does not depend on the outcome of executing F( ) at a node 104. That is, the validity of the transaction is not necessarily dependent on the function F( ). Rather the function F( ) defines a set of “payment channel rules” according to which a payment channel is implemented off-chain. The implementation of the payment channel will therefore be dependent on the execution of F off-chain (whether it is coded in Script or non-Script), but the validity of any published transaction will not necessarily depend on F (even when it is encoded in Script).

### Accommodating Zero-Functions

One final consideration to be made is that, in some cases, F( ) is implemented in Script, and the execution of F( ) is part of the locking or unlocking script. It is possible that the output values (Pᵢ of an iteration may take the value ‘zero’, which would invalidate the transaction. This might be desirable as it can be a signal for ending the loop. However, if this is not the case, then the zero value can be replaced with some placeholder such as α, for some non-zero value a, and by appending a conditional Bitcoin script statement to the functional unit:

```
[G( )] = [F( )]OP_DUP OP_IF
                          OP_NOP
                    OP_ELSE
                          OP_DROP <α>
                    OP_ENDIF
```

Where [F( )] represents the functional unit of code in Bitcoin script and [GO] now represents a version of that repeating unit that accommodates zero-valued outcomes. If a is chosen carefully, it can also serve as a flag for some special event, such as reaching the end of the loop.

### 3.1.3 Transactions in PCLs

In this section, a number of possible “skeleton” transaction structures are described that can be used to implement a general PCL. These transactions are classified according to the terminology established for payment channels in section (2.2): the funding, update-phase and settlement transactions respectively.

### The Funding Transaction

In a PCL, a funding transaction F plays the dual roles of (i) escrowing the participants' funds to the payment channel and (ii) also establishing the functional unit F( ) to be used in the looping process.

Role (ii) is a key feature of the described funding transaction F in a PLC—the funding transaction F serves to immutably record the set of rules according to which the payment channel must be implemented—those rules being embodied in the function F( ). These rules are agreed by the parties who sign the funding transaction F, and the funding transaction F serves as immutable proof of the agreed rules once committed to the blockchain 150.

The funding transaction F may contain the code embodying function F( ), or it may otherwise evidence that code. For example, the code may be contained in another transaction committed to the blockchain 150 and the function transaction F may evidence that code by way of a hash value or other unique identifier of that code contained in the funding transaction F.

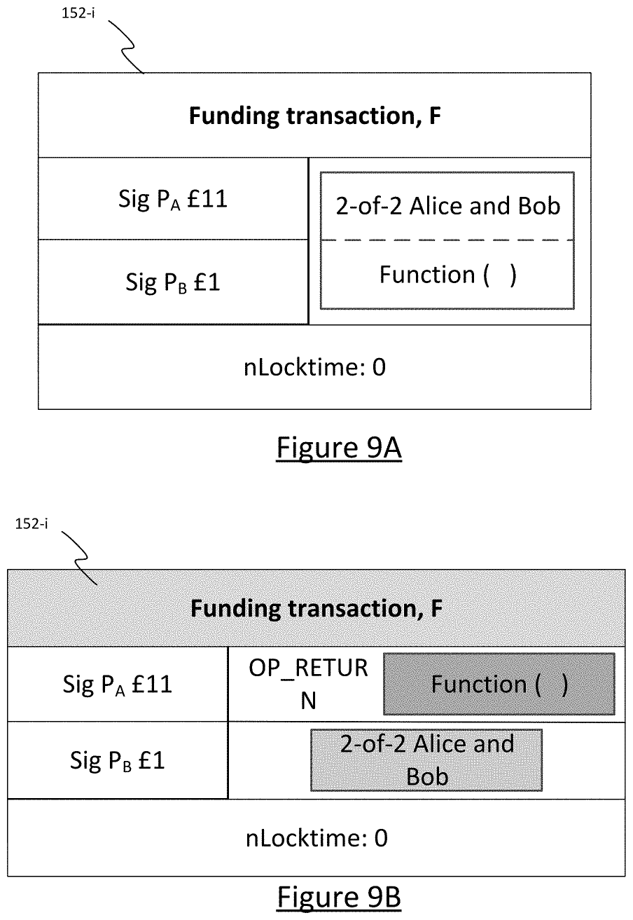

For the case of a bidirectional payment channel, and wherein the functional unit is written in Script, a funding transaction F can be constructed as depicted schematically in FIG. 9A. Consistent with FIGS. 2A and 8, the funding transaction F is denoted by reference sign 152-i. The repeating unit is part of a spendable script in this example.

In this case, there is only a single output, which includes two distinct portions of script. The first is a simple 2-of-2 multisignature script required to jointly escrow funds for a bidirectional payment channel. The second is the repeating functional unit F( ), written in Script in this example.

Another motivation for including the function F( ) in the funding transaction F is that it only needs to be written and stored once, rather than creating multiple duplicate copies as would be the case if the functional unit F( ) were to reside in the update-phase transactions 600. The funding transaction is set out in further detail below, as Transaction 1.

Funding Transaction, TxID_{F}

| Inputs | | Outputs | |
|---|---|---|---|
| Value | Script | Value | Script |
| 11 BSV | nSequence: 0xFF . . . F | 12 | OP_2 <P_{A}> <P_{B}> OP_2 |
| | <Sig(P_{A},Tx_{F})> <P_{A}> | BSV | OP_CHECKMULTISIG |
| | | | [Function( )] |

| | |
|---|---|
| 1 BSV | nSequence: 0xFF . . . F |
| | <Sig(P_{B},Tx_{F})> <P_{B}> |

nLocktime: 0

Transaction 1: A funding transaction (in detail) where the repeating unit is part of a spendable script.

Alternatively, if the functional unit is written in a different programming language, a similar funding transaction can be constructed, shown in FIG. 9B.

In this case two outputs are provided that separate the multisignature script from the functional unit, which is now written in a non-Script language. To accommodate this, the unit of code is stored in an unspendable (e.g. OP_RETURN) output, meaning this part of the transaction will never be executed by miners during the transaction validation process.

The funding transaction of FIG. 9B is set out in further detail below, as Transaction 2.

Funding Transaction, TxID_{F}

| Inputs | | Outputs | |
|---|---|---|---|
| Value | Script | Value | Script |
| 11 BSV | nSequence: 0xFF . . . F | 0 BSV | OP_0 OP_RETURN |
| | <Sig(P_{A},Tx_{F})> <P_{A}> | | [Function( )] |
| 1 BSV | nSequence: 0xFF . . . F | 12 BSV | OP_2 <P_{A}> <P_{B}> OP_2 |
| | <Sig(P_{B},Tx_{F})> <P_{B}> | | OP_CHECKMULTISIG |

nLocktime: 0

Transaction 2: A funding transaction (in detail) where the repeating unit is stored in an OP_RETURN output.

In the set-up phase of a PCL, a corresponding refund transaction R is created for the funding transaction F as part of the initial step S0. The refund transaction R has nSequence value of 0 (or anything less than the maximal value) and an nLocktime value set to T_{R} in the future.

An example of such a refund transaction is shown as Transaction 3 below.

Refund Transaction, TxID_{R}

| Inputs | | Outputs | |
|---|---|---|---|
| Value | Script | Value | Script |
| 12 | nSequence: 0 | 11 BSV | OP_DUP OP_HASH160 <P_{A}> |
| BSV | <Sig(P_{A},Tx_{R})> <P_{A}> | | OP_EQUAL VERIFY |
| | <Sig(P_{B},Tx_{R})> <P_{B}> | | OP_CHECKSIG |

| | |
|---|---|
| 1 BSV | OP_DUP OP_HASH160 <P_{B}> |
| | OP_EQUALVERIFY |
| | OP_CHECKSIG |

nLocktime: T_{R}

Transaction 3: A refund transaction (in detail) spending the output of the funding transaction.

This refund transaction R simply spends the spendable outputs of the funding transaction F used to escrow funds to the channel. The purpose of the refund transaction R is simply to return the initial state of funds back to the participants in case no further states Iₙ are mutually signed during the update phase of the PCL. Note that the refund transaction R can take exactly the same form, irrespective of whether the type of funding transaction F shown in FIG. 9A or FIG. 9B is used.

### The Loop Transaction

The transactions corresponding to the update-phase of the payment channel are herein renamed loop transactions, because these will represent the inputs and outputs of each respective iteration of the loop. That is, each transaction of the series of spending transaction 600 shown in FIGS. 6-6B is referred to as a loop transaction.

Each loop transaction Iᵢ contains a set of values Vᵢ:=(ϕᵢ, ωᵢ), representing the respective inputs and parameters to be consumed in the next iteration of the loop. Recall that in general it is plausible that the values (ϕᵢ, ωᵢ) may reside anywhere inside a transaction. However, for simplicity they are shown here in the inputs. It may be advantageous however, to alternatively store these values in outputs (e.g. an OP_RETURN output) because these will become part of the signed message of a transaction, whereas input scripts are not themselves part of the signed message.

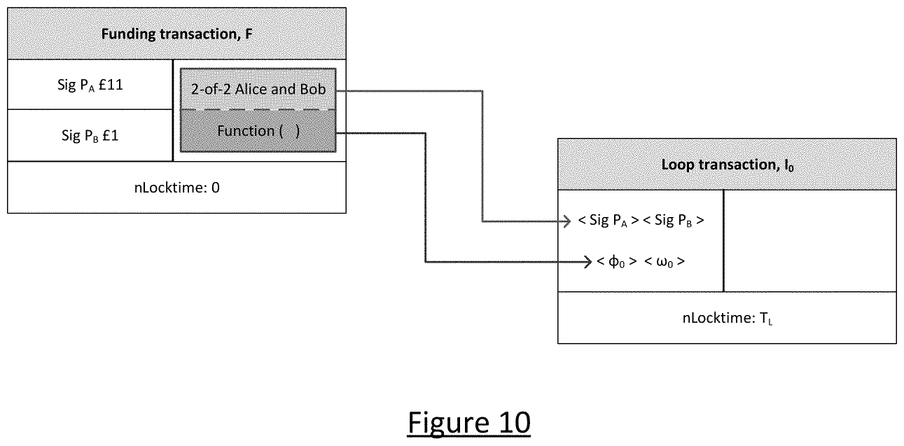

FIG. 10 shows specifically an initial loop transaction I₀ shown spending the output of a funding transaction F. As shown in FIGS. 6-6B, the initial loop transaction I₀ is created in the first step of the payment channel negotiation S1 (immediately after the initial step S0 that establishes the funding and refund transactions F, R).

FIG. 10 shows a loop transaction, and depicts how its inputs sends the spendable output of the funding transaction. As expected for a Funded Nakamoto payment channel, the loop transaction has an nLocktime value set to some time T_{L} in the future, and its nSequence value is non-maximal.

The outputs of the loop transaction can take any form.

Two examples of loop transactions are given below, as Transaction 4 and Transaction 5, both representing the i^{th} iteration of the loop Iᵢ where i is an integer between 0 and the maximum value M. Recall that this transaction is necessarily locked until a time T_{L} in the future, and the nSequence value increments until the maximum value M is reached or the time T_{L} elapses.

The first example shows a loop transaction whereby the inputs ϕᵢ and the parameters ωᵢ for the i^{th} iteration of the loop are stored in the inputs of the loop transaction.

The second example shows a loop transaction where ϕᵢ and ωᵢ are instead stored in an OP_RETURN output. This has the added benefit that the values and parameters may be part of the message signed by the signatures in the input of the transaction, which can be achieved with an appropriate choice of SIGHASH flags (e.g. SIGHASH ALL).

Note that in both cases, for simplicity, the payment values in the outputs are shown to be monotonically increasing (1+i) or decreasing (11−i), as in the case of unidirectional channel. However, this is not required in general—the digital asset value(s) of the output(s) can change or stay the same depending on the outcome of the execution of the payment loop function F( ).

Loop transaction Iᵢ, TxIDᵢ

| Inputs | | Outputs | |
|---|---|---|---|
| Value | Script | Value | Script |
| 12 | nSequence: i | 11 − i BSV | OP_DUP OP_HASH160 <P_{A}> |
| BSV | <Sig(P_{A},Txᵢ)> <P_{A}> | | OP_EQUALVERIFY |
| | <Sig(P_{B},Txᵢ)> <P_{B}> | | OP_CHECKSIG |
| | <σᵢ> <ωᵢ> | | |

| | |
|---|---|
| 1 + i BSV | OP_DUP OP_HASH160 <P_{B}> |
| | OP_EQUAL VERIFY |
| | OP_CHECKSIG |

nLocktime: T_{L}

Transaction 4: A loop transaction Iₖ (in detail) where the inputs and parameters are stored in the input.

Loop transaction Iᵢ, TxIDᵢ

| Inputs | | Outputs | |
|---|---|---|---|
| Value | Script | Value | Script |
| 12 | nSequence: i | 0 BSV | OP_0 OP_RETURN |
| BSV | <Sig(P_{A},Txᵢ)> <P_{A}> | | <ϕᵢ> <ωᵢ> |
| | <Sig(P_{B},Txᵢ)> <P_{B}> | | |

| | |
|---|---|
| 11 − i BSV | OP_DUP OP_HASH160 |
| | <P_{A}> |
| | OP_EQUALVERIFY |
| | OP_CHECKSIG |
| 1 + i BSV | OP_DUP OP_HASH160 |
| | <P_{B}> |
| | OP_EQUALVERIFY |
| | OP_CHECKSIG |

nLocktime: T_{L}

Transaction 5: A loop transaction Iₖ (in detail) where the inputs and parameters are stored in an output.

### The Settlement Transaction

The settlement transaction S has exactly the same data as the most recent loop transaction, but it now has a maximal nSequence value. This disables the nLocktime value and causes the settlement transaction to be valid for mining onto the blockchain 150.

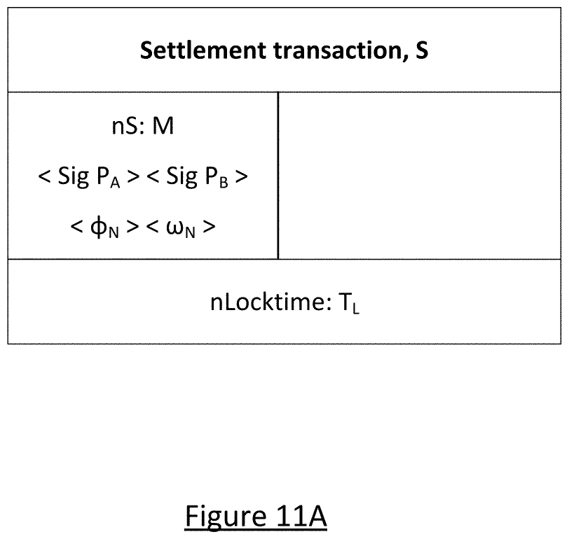

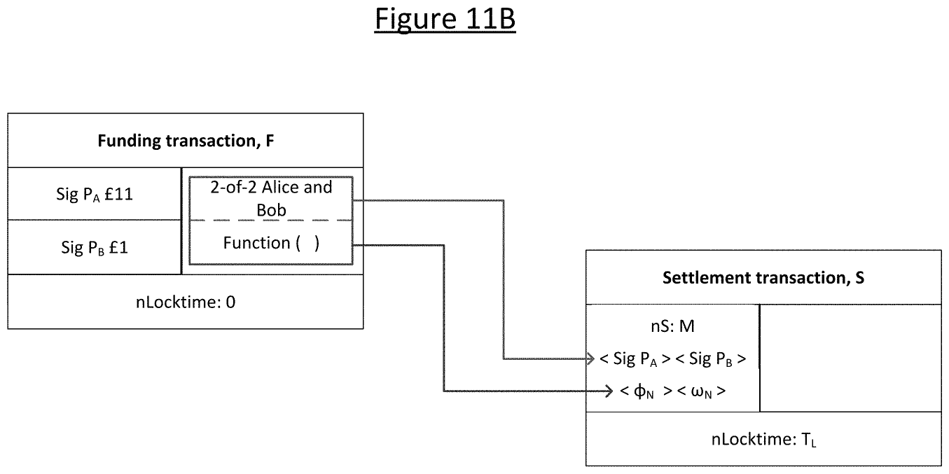

FIG. 11A schematically depicts an example settlement transaction S.

FIG. 11B schematically depicts how the settlement transaction spends S the original funding transaction F.

A detailed example of a settlement transaction S is shown below as Transaction 6. This assumes settlement after N iterations of the loop (hence ϕ_{N}, ω_{N}).

Settlement transaction S, TxID_{S}

| Inputs | | Outputs | |
|---|---|---|---|
| Value | Script | Value | Script |
| 12 | nSequence: 0xFF. . . F | 0 BSV | OP_0 OP_RETURN |
| BSV | <Sig(P_{A},Txₛ)> <P_{A}> | | <ϕᵢ> <ωᵢ> |
| | <Sig(P_{B},Txₛ)> <P_{B}> | | |

| | |
|---|---|
| 11 − N BSV | OP_DUP OP_HASH160 |
| | <P_{A}> |
| | OP_EQUALVERIFY |
| | OP_CHECKSIG |
| 1 + N BSV | OP_DUP OP_HASH160 |
| | <P_{B}> |
| | OP_EQUALVERIFY |
| | OP_CHECKSIG |

nLocktime: T_{L}

Transaction 6: An example settlement transaction S (in detail) where the inputs and parameters are stored in an output.

### 3.1.4 Implementing the Loop

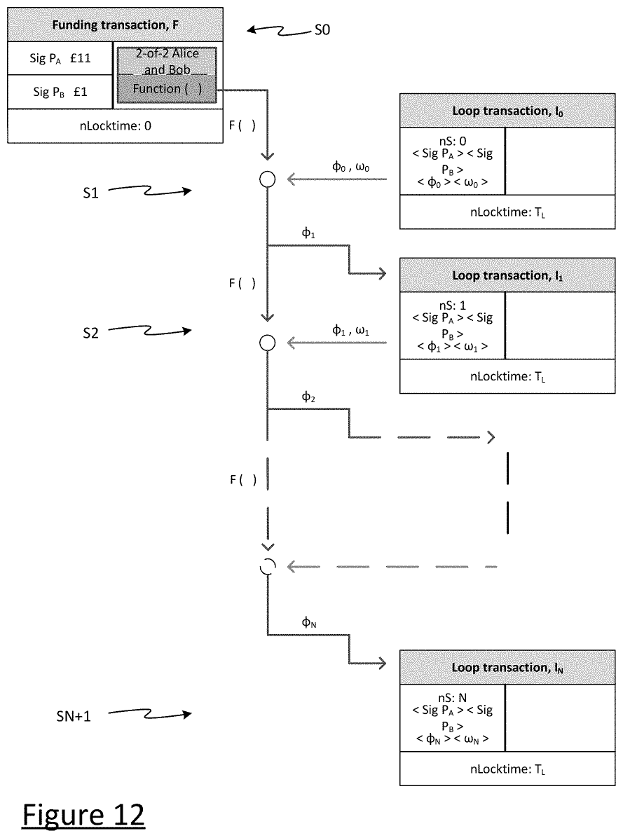

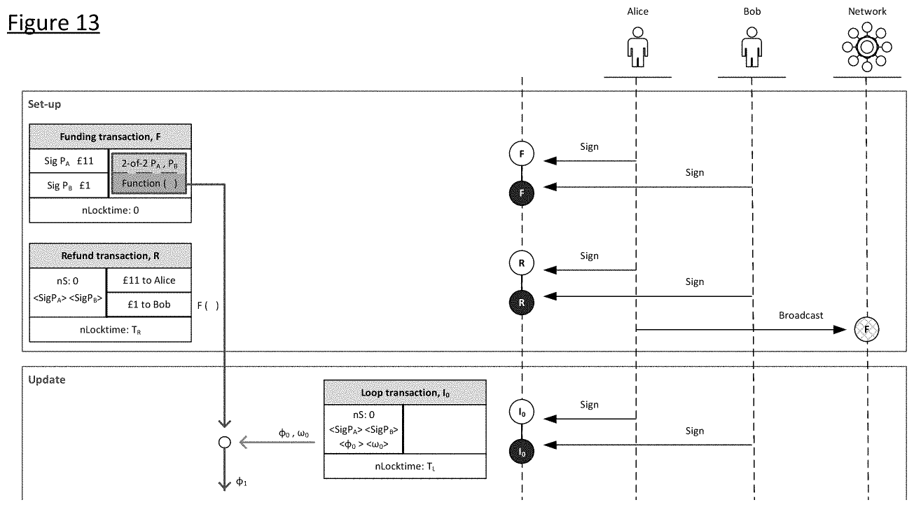

FIG. 12 shows a flow diagram to illustrate how the looping functionality of a PCL is implemented using a combination of the functional unit F( ), as established in the funding transaction F, with the loop transactions I₀, I₁, I₂, . . . created during the update-phase of the payment channel.

The first loop transaction I₀ includes the initial set of input and parameter values (ϕ₀, ω₀), which are not produced via execution of the functional unit. These values are the initial state from which the looping process will start.

Each subsequent loop transaction I₁, . . . , I_{N} for N≤M is the result of the functional unit F( ) having been applied to the previous transaction as an operator. For example, I₁=F(I₀), I₂=F(I₁) and so on. This can also be understood as the functional unit being applied to the previous set of inputs and parameters: ϕᵢ=F((ϕᵢ₋₁, ωᵢ₋₁)).

As indicated, the functional unit F( ) may also compute the digital asset value or values of the output or outputs of each loop transaction Iᵢ. Those digital asset value(s) are denoted vᵢ, and the digital asset value(s) of the previous transaction Iᵢ may be used to do this. According to the above definition, the digital asset value(s) vᵢ are a form of input value ϕᵢ. That it to say, the input value(s) ϕᵢ may consist of or include the digital asset value(s) vᵢ of the loop transaction Iᵢ. At times, the present disclosure draws a distinction between digital asset value(s) vᵢ and input value(s) other than the digital asset value(s) vᵢ, and for the latter, the notation ϕ′ᵢ may be used. Examples of input value(s) ϕ′ᵢ other than the digital asset value(s) vᵢ include. As a particular example, non-digital asset input value(s) ϕᵢ₋₁ of the previous transactions Iᵢ₋₁ may be used to calculate the digital asset value(s) vᵢ of the current transaction Iᵢ:

vᵢ=F(ϕ′ᵢ₋₁)

noting that F may take other arguments and/or return additional input value(s).

In general, the functional unit F( ) can take only inputs ϕᵢ, only parameters ωᵢ or both.

By way of further example, the functional unit F( ) could have the effect of:

2) Generating and inserting a new type of data field to Iᵢ (as opposed to changing an existing data field) which does not correspond to any existing data field in the previous transaction Iᵢ₋₁. An example would be adding an OP_RETURN output to the transaction Iᵢ.

3) Removing an existing type of data field from Iᵢ₋₁, i.e. such that the previous transaction Iᵢ₋₁ contains a data field which does not correspond to any data field in the newly-created transaction Iᵢ.

The functional unit F( ) is taken from the funding transaction F for each iteration of the loop, which can be stored in memory and non-duplicated.

The execution of any one iteration of the loop is done off-chain, i.e. each step S1, S2, . . . , SN+1 is off-chain.

Both parties sign on each new state Iᵢ (i.e. new loop transaction) to represent the progress of the computation of the loop. Once both parties have signed on one state, they can continue by executing the functional unit F( ) once again to produce the next state Iᵢ₊₁ to sign.

### 3.2 Bidirectional PCLs

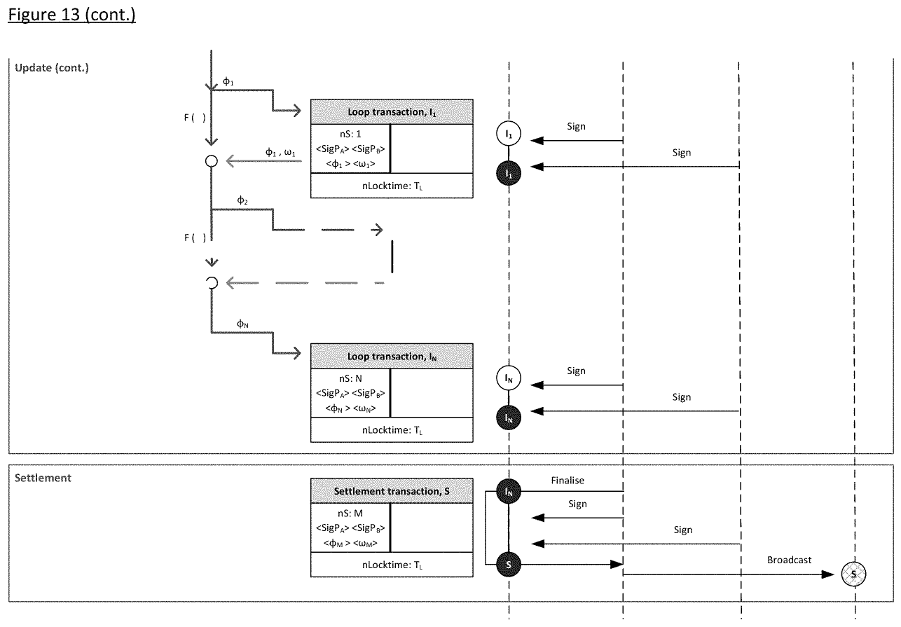

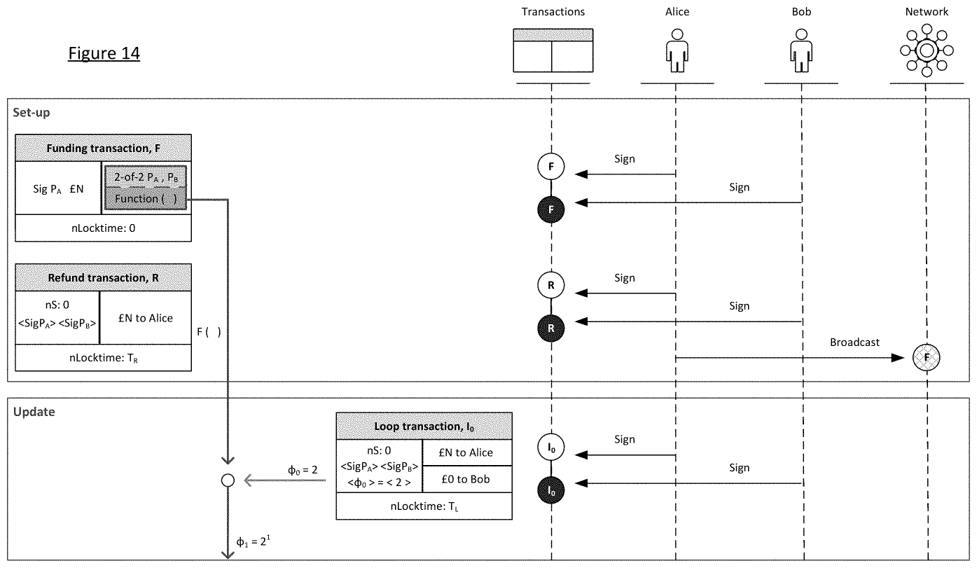

FIG. 13 shows an example process flow for implementing a bidirectional payment channel based on payment channel loops.

The previous section establishes a generalised framework for implementing looping functionality inside a payment channel. This includes a set of transaction templates, and a looping mechanism that uses them, which allows the looping to be executed off-chain.

The following example makes use of that framework to show how a bidirectional payment channel can be used to implement a simple loop of payments between two parties.

### Scenario

Consider two pool players, Alice and Bob. They wish to play a one-on-one tournament comprising a large number N of games. Alice and Bob also wish to wager money on the outcome of the tournament, but are aware there is a risk that one player may refuse to continue playing and walk away from the table at any point.

They therefore decide to use a bidirectional payment channel to ensure that the overall winnings are rebalanced in accordance with the proportion of games each player has one after each game. This way, each player can be cheated at most out of the winnings for one game.

Their payment channel proceeds as follows:
1. Alice and Bob each agree to wager W/2, where W is the total possible prize pool for the tournament.
2. Alice and Bob cooperate to construct:
   i. a funding transaction escrowing their total funds W; and
   ii. a corresponding refund transaction, time-locked to T_{R} in the future.
   Note that the spendable output of the funding transaction includes a functional unit F( ), which will update the number time Alice has won and increment the total number of games by one each round. This is written in Bitcoin script as:

[F( )] = OP_IF
<1> OP_ADD
OP_ENDIF
OP_SWAP <1> OP_ADD OP_SWAP

3. After each round of pool, Alice and Bob construct a loop transaction, with nLocktime set to a time T_{L} in the future, and spending the funding transaction. This transaction has input containing:
   i. ϕᵢ={Total No. Games, No. Games won by Alice already}={K, k_{A}}
   ii. ωᵢ={Outcome of this round}=1(Alice wins) or 0 (Alice loses) (note 0 and 1 can be any values that denote a win and a loss by Alice respectively)
4. This process is repeated until either the total number of games N is reached, and

Alice and Bob settle, or one party decides to stop playing and they settle prematurely.

In this scenario, the repeating unit F( ) updates the number of games won by Alice and the total number of games played each round. This means the payment amounts can be rebalanced in proportion to games won by each player, k_{A}/K: 1−k_{A}/K, in each loop transaction.

Observations about Bidirectional PCLs

As it is a bidirectional channel, the final state may favour either party. It is expected that this party will check the final state of the transaction, and they are incentivised to publish that final state to be mined.

The redistribution of funds between any two consecutive states of the channel may favour one party or the other. It is expected that at least one party, most likely the party favoured by each state transition, will check the most recent state (i.e. output of a state transition). When a party chooses to ‘settle prematurely’, they are merely broadcasting the most recent state once T_{L} has elapsed, rather than continuing to increment nSequence further.

Neither party is able to cheat the other by publishing an earlier transaction because of the effect nSequence and nLocktime values in the update-phase transactions. If one party does publish an earlier state, the other can simply publish a more recent state (with greater nSequence), which will override the earlier state from the perspective of miners.

The act of creating and updating the transactions in the update phase may be performed by Alice, Bob or some off-chain oracle system (see section 4). The order in which each transaction is signed may also be dependent on the exact configuration of this process, as well as the situational requirements of the scenario in which the PCL is used.

The case here assumes the functional unit is written in Script, and stored in a spendable output. However, as noted, this may be replaced with a functional unit F( ) written in any programming language and stored in an OP_RETURN output or other unspendable output since, the execution of the body of the loop statements is performed off-chain.

### 3.2.1 Bidirectional PCLs

Possible use cases for bidirectional PCLs include:
Micropayments for utilities used on repeated basis;
Payment for monitoring services;
Commerce involving in-flows and out-flow from multiple merchants; and
Gaming involving repeated actions (e.g. turn-based RPGs).

### 3.3 Unidirectional PCLs

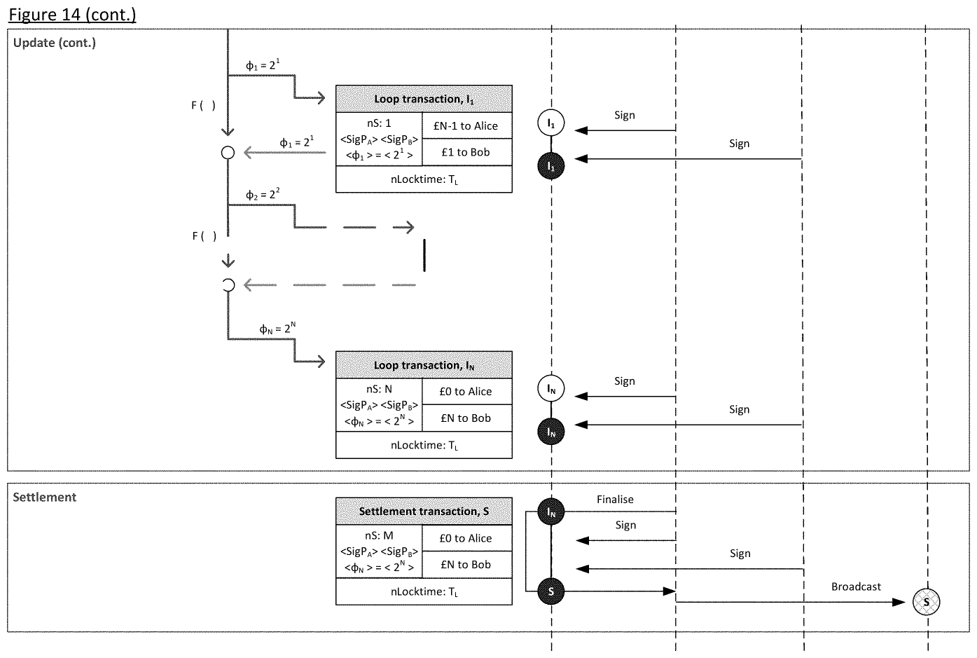

FIG. 14 shows a process flow for an example unidirectional PCL.

This section describes examples of how unidirectional PCLs may be used, as a special case of PCLs in general, to implement certain tasks. In particular, tasks such as:
Paid computation; and
Repeated micropayments.

The case of paid computation is considered for the following explanation.

### Scenario

Consider two parties, Alice and Bob. Alice is a researcher working in remote location, with little access to computational resources, while Bob is a service provider, specializing in ‘pay-per-computation’ services.

Alice wishes to pay bob to compute the value of 2^{N}, where N is a very large integer, such that Alice cannot efficiently compute the desired valuer herself. Bob offers to compute the value for Alice, in return for payment. However, he stipulates that he wishes to be paid incrementally, an amount k per computation, using micropayments.

In order to achieve this, Alice and Bob agree to implement a unidirectional PCL between them. The PCL variant chosen is unidirectional because Alice (payer) is always paying Bob (payee) in each iteration of the loop. Their payment channel loop proceeds as follows:
1. Alice and Bob agree on a price k=£1 per computation round. This is the amount that Alice will pay Bob for computing (ϕᵢ, ωᵢ)=F((ϕᵢ₋₁, ωᵢ₋₁)) in each iteration of the loop.
2. Alice and Bob cooperate to construct:
   i. a funding transaction escrowing Alice's total funds k×N; and
   ii. a corresponding refund transaction, time-locked to T_{R} in the future.
   The spendable output of the funding transaction includes a functional unit F( ), which simply multiplies a single input argument Vᵢ=ϕᵢ= [symbol] Argument [symbol] by 2, written in Bitcoin script as:
   [F( )]= [symbol] 2 [symbol] OP_MUL
3. Alice creates the initial loop transaction, which includes the initial input argument ϕ₀= [symbol] 2 [symbol] , which establishes the value to be multiplied by 2 using the functional unit.
4. Bob (or an oracle operated by Bob) constructs each subsequent loop transaction, which spend the funding transaction from step 2 and have nLocktime set to T_{L} in the future. The input of each loop transaction contains the newly calculated value ϕᵢ= [symbol] 2ⁱ [symbol] , for i>0.
5. This process is repeated until either the final value ϕ_{N}= [symbol] 2^{N} [symbol] is computed by Bob, or one party decides to terminate the interaction and settle prematurely.
   Observations about on Unidirectional PCLs

As it is a unidirectional channel, the final state will always favour Bob (the receiving party). It is expected that this party will check the final state of the transaction, and they are incentivised to publish that final state to be mined. Note that, because it is unidirectional, Bob is always incentivised to publish the final (or otherwise most recent) transaction.

The sending party (Alice) in a unidirectional channel is always incentivised to publish a non-final (or otherwise earlier) transaction. However, the mechanism of nSequence and nLocktime is used to prevent Alice from doing so. If Alice does publish an earlier state, then Bob can simply publish a more recent state (with greater nSequence), which will override the earlier state from the perspective of miners. When a party chooses to ‘settle prematurely’, they are merely broadcasting the most recent state once T_{L} has elapsed, rather than continuing to increment nSequence further.

The redistribution of funds between any two consecutive states of the channel may favour one party or the other. It is expected that at least one party, most likely the party favoured by each state transition, will check the most recent state (i.e. output of a state transition). However, in the case of paid computation, where all state transitions favour Bob (the receiver), it is expected that Bob will check new states of the payment channel funds.

The act of creating and updating the transactions in the update phase may be performed by Alice, Bob or some off-chain oracle system (see section 4). The order in which each transaction is signed may also be dependent on the exact configuration of this process, as well as the situational requirements of the scenario in which the PCL is used.

This assumes the functional unit F( ) is written in Script, and stored in a spendable output. However, as noted, this can be replaced with a functional unit F( ) written in any programming language and stored in an OP_RETURN output or other unspendable output since, the execution of the body of the loop statements is performed off-chain.

In practice, Alice is unlikely to be in a position to verify every computation by Bob (because, if she were in that position, she might be unlikely to outsource the computation in the first place). However, Alice can “sample” a limited number of computational results provided by Bob (e.g. using random sampling) and verify the computations herself to check they match.

### Function Variables in Funding Transaction

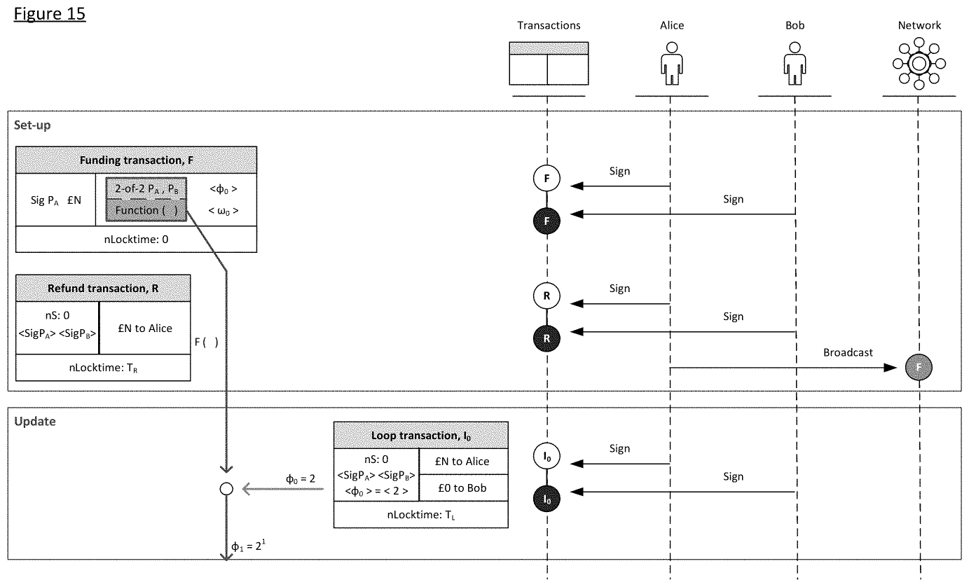

Note, in addition or an alternative to including the initial function variables (ϕ₀, ω₀) in the first loop transaction I₀, it may also be desirable to include or otherwise evidence the initial conditions, expressed as (ϕ₀, ω₀), in the funding transaction F itself. This would allow the initial state to always be published on-chain. In this case, the initial state can be compared to the state that is later published on-chain to close the channel in the settlement phase. By comparing the initial state and the settled state, both of which now reside on-chain, it can be seen how much of the looped process was executed i.e. whether it reached the expected termination point or whether it was prematurely terminated. An example of a unidirectional PCL employing this principle is shown in FIG. 15. This shows the early steps of the process, and in contrast to FIG. 14, the initial values (ϕ₀, ω₀) are taken from the funding transaction F; thereafter the process continues as in FIG. 14. Note, although a unidirectional PCL is considered by way of example, this applies equally to a bidirectional PLC.

Evidencing Input Values ϕᵢ/Parameters ωᵢ in Settlement Transaction S

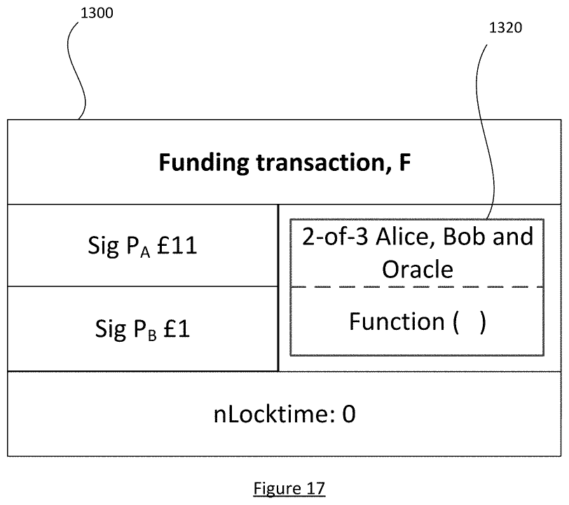

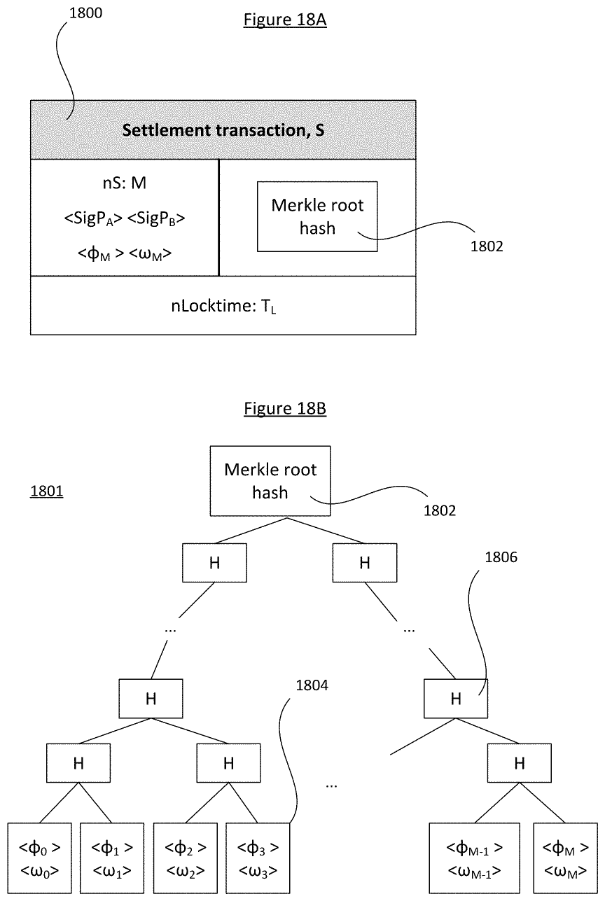

FIG. 18A shows a settlement transaction S, denoted by reference numeral 1800, in which an additional piece of information 1802 is contained. The additional piece of information 1802 evidences the full sequence of inputs and/or parameters that resulted in the settlement transaction 1800, i.e. (ϕ₀, ω₀), (ϕ₁, ω₁), . . . , (ϕ_{M}, ω_{M}). In the present example, that piece of information takes the form of a Merkle root hash 1802 of a Merkle tree 1801 shown in FIG. 18B.

FIG. 18B shows the Merkle tree 1801 to comprise a plurality of leaf nodes 1804, each of which represents one set of inputs/transactions (ϕᵢ, ωᵢ). For example, each leaf node 1804 may be a hash of that set. The sets of inputs/parameters are ordered by root iteration. i.e. from 0 to M. The Merkle tree also comprises a hierarchy of intermediate nodes 1806. A lowest level of intermediate node is created by hashing a pair of non-leaf nodes, and each intermediate node at any level above that is created by hashing a pair of non-leaf nodes one level below—all the way up to the root hash 1802. The verb “to hash” in this context means “to generate by applying at least one cryptographic hash function”, so includes double hashing etc. Merkle trees are known per se as a data structure for evidencing and efficiently verifying sequenced data elements. Therefore the structure of the Merkle tree 1802 is not described in further detail. Suffice it to say that the root hash 1802 concisely and robustly evidences the entire sequence of inputs/parameters.

Once the settlement transaction S has been published, the functional unit F( ) in the funding transaction F (now spent by the committed settlement transaction S) can be used to verify the settlement transaction S, e.g. to verify the final distribution of digital asset defined by the value(s) v_{M} of its output(s) (assuming the functional unit F( ) is used to compute those value(s) vᵢ) given a verifiable sequence of input values/parameters. The given sequence of input value's/parameters can be verified by using that sequence to compute a reconstructed root hash for comparison with the root hash 1802 in the settlement transaction S.

A Merkle root hash 1802 is just one example of a piece of data that can evidence the input value/parameter sequence. For example, a simple hash, double hash etc. of the sequence could be used instead, or indeed the sequence itself could simply be included in the settlement transaction S of that information is non-sensitive. A Merkle tree 1801 has the benefit that any single set of input values/parameters (ϕᵢ, ωᵢ) can be verified as belonging to the Merkle tree 1802 using a Merkle proof, and the ability to do this may be beneficial in certain circumstances—but not necessarily required. Merkle proofs are known per se and not described herein.

### 3.3.1 Use Cases

Possible use cases for bidirectional PCLs include:
Paid computation; or
Recursive merchant-customer interactions e.g. payment of micro-subscriptions.

### 3.4 Further Considerations

### Incentive Models

Payment channels rely at least to some extent on incentive models to ensure that no one participant in the channel may successfully cheat any other participant, such that the latter receives less than they otherwise would have. The broad incentive models for the payment channels described herein are as follows:
Nakamoto—both parties are incentivised not to cheat primarily due to circumstance. If the participants have been updating the state of a transaction, it would be damaging to their relationship should one party choose to double-spend their input and invalidate the negotiation.
Funded Nakamoto—at any point in time, either party may be incentivised to cheat depending on the state of the channel. However, the features (i) funding transaction in set-up; and (ii) nSequence and nLocktime, are used to mitigate the incentive to cheat by ensuring that neither party is able to successfully cheat the other by publishing an earlier version of a transaction.

### The Security and Efficiency Trade-Off

When choosing a payment channel architecture for a particular use case, one will generally be met with a trade-off; specifically between security and efficiency. These terms are defined broadly as:
Security—because payment channels generally involve the transfer of funds between multiple parties, care must be taken to ensure that neither party may practically cheat the other out of funds. The security of a channel is therefore an expression of the ability of a participating party to cheat.
Efficiency—for payment channels, efficiency may refer collectively to the amount of data that must be exchanged, latency that must be incurred and financial cost that must be sacrificed in order to implement the channel to achieve a particular goal.

In general, a choice needs to be made between using a Funded Nakamoto channel, which has high-security, and using a Nakamoto channel, which has high-efficiency.

FN channels are described as ‘high-security’, as mentioned in section 2.2.2, for two reasons. The use of nSequence and nLocktime in conjunction mitigates the possibility that a state that is older than the final or current state is mined. In addition, the use of a funding transaction mitigates the possibility that either party can ‘double-spend’ the funds contributed to the channel by committing them to mutual escrow in the set-up phase.

Nakamoto channels are described as ‘high-efficiency’ because they do not require a funding transaction (nor associated refund transaction). This means that not only is the set-up phase much more succinct and less data-intensive, but the channel only requires for one transaction to published and mined, which reduces the total value in ‘transaction fees’ required to implement the channel.

Consider, for example, the scenario where Alice and Bob are a customer and a highly-reputable merchant respectively. They mutually wish to use a payment channel to record a set of recurring purchases of an item without publishing a transaction for each individual purchase. A Nakamoto payment channel would lend itself well to this scenario because Alice and Bob have external, real-world reasons to trust the other party, which make efficiency the primary consideration.

Conversely, if Alice and Bob are distant peers connected over the internet, wishing to exchange data via a payment channel, each party may be unable to validate trustworthiness of the other. In this case, security would be the primary concern, and thus an FN channel may be the better option.

The key point is that different payment channels may be used to perform the same tasks, or different tasks, depending on the situation. When introducing the concept of Payment Channel Loops in section 4, this reasoning applies also. The fact that a particular loop is shown to implemented using one architecture does not necessarily preclude it from being implemented using another.

### Update-Phase Race Conditions

In channels that involve nSequence and nLocktime—Nakamoto and FN architectures—it is possible that a race condition may occur if two conflicting states, with non-finalised nSequence value, are published near their common locktime T_{L}.

The issue lies in the fact that two such alternative versions, with different nSequence values but a common nLocktime value T_{L} will both appear independently as valid once the locktime is reached. It is therefore possible that one version I₁ (i.e. the earlier version, favouring Alice) could be published by Alice near T_{L} and be mined very quickly.

Although Bob can see when the earlier version is published, and respond by publishing the more recent version I₂ (favouring Bob), there is still a non-zero probability that I₁ may be mined before I₂ which is tantamount to double-spend in the channel.

The probability of such an event is highly unlikely, given that all mining nodes are likely to receive both transactions (if broadcast in quick succession) before a new block is found, and any honest miner would drop I₁ and deem I₂ the only valid version given its higher nSequence number. Nonetheless, there are many ways in the risk of such a scenario can be mitigated, two of which are:
Variable nLocktime—decreasing the value of nLocktime in the update phase transaction each time the nSequence value is increased ensures that the most recent version of a transaction will always become valid to mine earlier than an older version.
Fee incrementation—by increasing the total transaction fee for each new version of the update-phase transaction, miners can be incentivised to mine the most recent version simply on the basis of profitability.

### Receiver Checking

With reference to sections 3.2 and 3.3 in particular, there is an onus on at least one of interacting parties (or an oracle; see section 4) to check the values of the funds distributed in the outputs of each update-phase transaction in a PCL.

In general, this will likely be the responsibility of whichever party acts a ‘receiver’. As discussed in section 2 (‘directionality’), either party may be a net beneficiary of a given state transition in both bidirectional and unidirectional PCLs. Therefore the onus may be on either party to check the allocation of funds, and indeed the integrity of the transaction itself, for any state transition. However, in unidirectional channels, the final state should always be checked by the overall receiving party.

### Verification of ϕᵢ Values

A key feature of the PCL architectures are that input/output values ϕᵢ are updated in each iteration of the loop, according to the repeating unit, as: ϕᵢ=F((ϕᵢ₋₁, ωᵢ₋₁)).

However, this is generally done by a ‘computing party’ (e.g. Bob), so for the description has omitted any consideration of how the ‘non-computing party’ (e.g. Alice) may verify the correctness of an output value ϕᵢ for a given input value ϕᵢ₋₁. In general, there are at least three methods may be used to do this:
Trap-door functions—if the repeating unit involves finding a solution to a computationally difficult trap-door problem, such as finding a hash digest under a target value by repeated hashing, then the final result will have a trap-door for fast verification. This means the non-computing party will be able to quickly verify that the final value ϕ_{N} given by the computing value is indeed correct and valid.
Random spot-checking—because it is expected that the repeating unit will be reused for every iteration of the loop, it is possible for the ‘non-computing party’ to take a single input ϕᵢ₋₁ and verify that it produces the correct candidate output ϕᵢ as calculated by the ‘computing party’. The non-computing party may do this at any point in the loop, and at random intervals, which means that the behaviour of the computing party can be checked at any instance in time.
Use of oracle system—the functional unit F( ) may be set up within some kind of oracle-based system, where the ‘rules’ of how the oracle operates are well known and auditable ahead of time. See section 4 below.

### 3.5 Chained PCLs

There is a limit to the number of operations that can be implemented within a single PCL process. In Bitcoin, this is currently approximately 4.3 billion, or rather 2³²−1 operations. This is expected to be sufficient in most practical contexts.

Nevertheless, it is possible to overcome this limit simply by chaining multiple PCLs together. In this way, the maximum number of operations can be extended to any arbitrarily large number, where each individual PCL process is used to cover up to approximately 4.3 billion operations.

### Method

The method for implementing PCLs is simply to treat the settlement phase of one PCL as the set-up phase of the next PCL.

This involves modifying the normal settlement phase of a PCL in the following way:
In a normal, singular PCL the settlement phase simply involves finalising the most recently signed update-phase transaction, by signing a transaction representing the same state but with an nLocktime value of 0. This allows the most recent state to be broadcast and published to the blockchain. This transaction submitted to the blockchain represents the final state of the channel, and has outputs to both parties that reflect this final state.
To implement a series of chained PCLs, the settlement of one PCL involves signing a final state that locks funds to a multi-signature output, rather than to multiple outputs to the multiple involved parties. By locking to a multisignature output, the settlement transaction becomes functionally equivalent to a funding transaction, which can be used to begin the next PCL.
A new refund transaction is signed, spending the output of the new funding transaction back to the participating parties according to the final state of the previous PCL. This ensures that the outcome of the previous PCL is preserved as the default refund outcome of the next PCL.

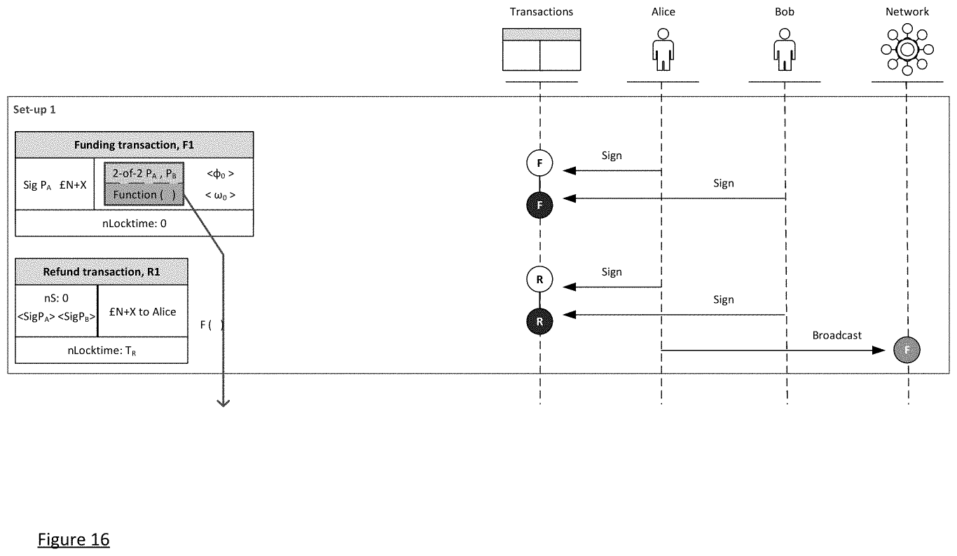

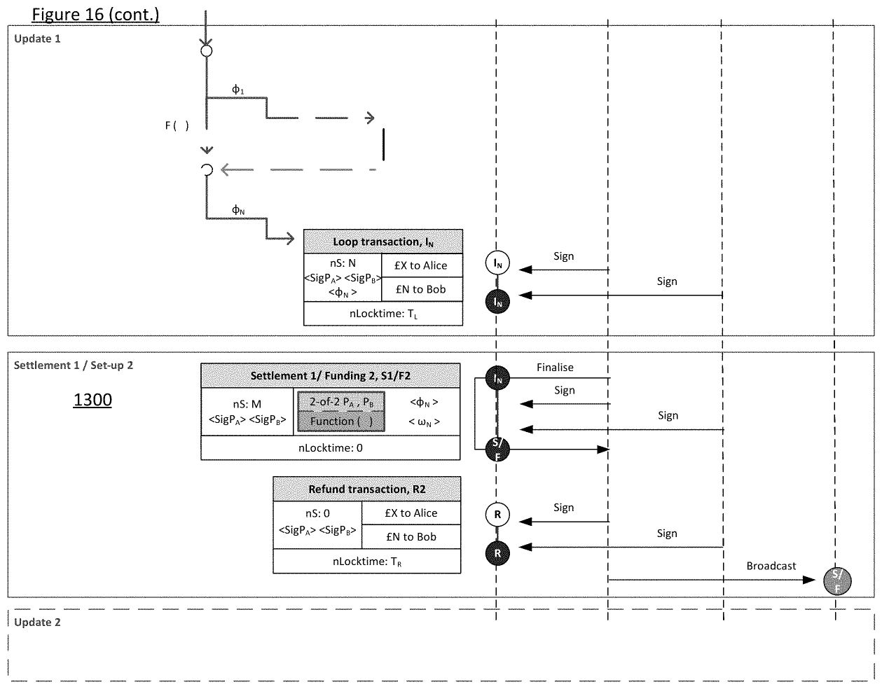

This design for a series of chained PCLs is outlined in FIG. 16. A sector labelled 1300 highlights the crossover between the first and second PCLs (note, the settlement of the first PCL and the set-up of the second PCL are treated as a single phase).

In this hybrid phase, the creation of the first settlement transaction (S1) is considered tantamount to the creation of the second funding transaction (F2). The second refund transaction (R2) is also shown, which spends the funds of F2 back to the participants in exactly the same way as in the final update-phase transaction (I_{N}) of the first PCL.

### 4. Payment Channel Oracles

Section 3 considered two participating parties Alice and Bob, acting in a peer-to-peer fashion. In each case, at least one of the two parties is relied upon to perform the off-chain execution of the repeating code unit F( ) of the loop.

However, it is possible to generalise this off-chain process and delegate it to the role of an oracle (e.g. the oracle 102o in FIG. 3A, or the oracles 102o−1, 102o−2 in FIG. 3B), which reads each successive loop transaction, in conjunction with the initial funding transaction, and executes the function to produce the next transaction.

Trusted oracles per se are a known concept in blockchain technology. A typical role of a trusted oracle is to provide a trusted source of external data that may, for example, be time dependent. An example might, for example, be where a smart contract in an account-based model is executed in dependence on current weather conditions, or the outcome of a sporting event, where that information is provided by a mutually-agreed oracle.

In the present context, the status of a trusted oracle is similar in that a particular trusted oracle is agreed by two parties, however the tole of the trusted oracle is to apply a predefined (and pre-agreed) set of rules for creating payment channel transactions—namely, the rules encoded in the functional unit F( ).

An execution oracle is permitted to construct transactions in the payment channel. Transactions may be parameterised as:
1. Locktime,
2. Sequence number,
3. Outputs
   a. Index,
   b. Value,
   c. Locking script.

That is, the execution oracle can set the locktime, the sequence number, or the outputs of a transaction according to the computation results from an iteration. Note that, for simplicity, it is assumed the input of the transaction is the outpoint from the funding transaction, which cannot be changed by the oracle. Once the oracle creates a new version of the spending transaction, the relevant participants can sign the transaction.

There are a certain rules that applies to any implementation of such oracle:
1. LOCKTIME: T_{L}_{ᵢ}≤T_{L}_{_{i−1}}≤T_{L}.
2. Sequence number: max>sᵢ>sᵢ₋₁>0.
3. The total output value is equal to or less than the value of the funding transaction or the total value given by the inputs.

This may be generalised by allowing any implementation of an oracle or many oracles in a payment channel. If all participants in the payment channel agree on a set of rules implemented as oracles, all transactions exchanged via the payment channel will have to follow the new rules in addition to being valid under the bitcoin protocol.

That is, a payment channel offers an instance of a customised interaction channel with functionalities and utilities, of which the security and payments are backed up by the bitcoin protocol.

### 4.1 Chess Payment Channel

A first example is considered in which Alice and Bob can play chess against each other. The core idea here is to implement a trusted oracle that enforces the rules of chess—encoded in the functional unit F( ). Note this example is used to introduce concepts that are generally applicable to any payment channel in which an oracle acts as an “intermediary” between two parties—i.e. as broadly illustrated in FIG. 3A. Although described in the context of the chess game example, the relevant description applies equally to any such scenario.

The oracle is trusted is the limited sense of being trusted not to collude with either player.

### Setup

Both Alice and Bob verify the source code that implements the chess oracle which can be provided by a third party. Alice, Bob, and the chess oracle create a 2-out-of-3 funding transaction F and the corresponding refund transaction R to open the chess payment channel. To make the game more exciting, both Alice and Bob are rewarded a small portion of the fund when they capture the other's piece.

A 2-out-of-three funding transaction has a transaction output which contains three public keys—of Alice, Bob and the oracle respectively—as operands of a 2-of-3 check multi-signature operate. Hence any two of Alice, Bob and the Oracle can unlock the output, by providing transaction signatures valid with respect to their specified public keys.

FIG. 17 shows an example of a 2-out-of-3 funding transaction F, denoted by reference numeral 1700. This particular funding transaction 1700 is the same as the “2-out-of-2” funding transaction 152-i of FIG. 9A, except for the fact that the spendable output of the funding transaction 1302 specifies three public keys—of Bob, Alice and the Oracle 102o— and requires only two valid transaction signatures to unlock, i.e. Alice+Bob can unlock, Alice+Oracle can unlock and Bob+Oracle can unlock.

The public key of the Oracle 102o constitutes a public identity of the oracle 102o—hence, by signing the funding transaction and committing it to the blockchain, Alice and Bob are, by choice, mutually authorized the Oracle 102o to act as an intermediary in the payment channel, and immutably recording that authorization in the blockchain 150. In this manner, each of the parties agrees the identity of the oracle 102o, and that agreement is immutably recorded in the funding transaction F. If any party does not have sufficient trust in the particular oracle, he/she/it is free to refuse to sign the payment transaction.

The role of the oracle 102o is to execute the functional unit F( ) specified in the funding transaction 1300 to create loop transactions (or at least component(s) thereof), and to provide one of the two required signatures for each loop transaction. It can be assumed that Alice and Bob will only sign the funding transaction 1300 if they each trust the oracle 102o to carry out that role as expected.

### Playing Chess

A chess game implemented via a payment channel is described move by move. In each move, the oracle 102o will prepare a transaction template for the player (Alice or Bob who take it in turns to select game moves). The functional unit F( ) is applied to verify each game move and update a game state of the game if the move is valid. In the above parlance, each game move is a parameter(s) ωᵢ (determined external to the loop—by the players and each game state is an input value(s) ϕᵢ (determined from by applying F( ) to the previous game state ϕᵢ₋₁ and the most recent move wᵢ₋₁).

The player will be able to read from the transaction
1. the current state of the chessboard, and
2. the distribution of the fund that reflects the current state of the chessboard.

The player then fills in their move in the OP_RETURN payload and signs the transaction.

When the oracle 102o receives the signed transaction, it checks the validity of the move and the signature. If both are valid, the oracle 102o signs the transaction to make up the 2-out-of-3 multiSig.

The oracle 102o applies the move to the chessboard and computes the resulting state. According to the new state, the oracle 102o computes the corresponding distribution of the fund between the two players. The oracle 102o then creates a new transaction template with a lower locktime, a higher sequence number and three updated outputs, one of which is the OP_RETURN payload containing the new state and all historical moves.

A list of transactions is provided below.

### Move 1:

Suppose Alice makes her first move. She gets a transaction template from the chess oracle 102o-, competes her move and signs the transaction.

TxID₁

| Version | 1 | Locktime | T_{L}_{₁} | |
|---|---|---|---|---|
| In-count | 1 | Out-count | 3 | |
| Input list | | | | |
| | Unlocking | Sequence | Output list | |
| Outpoint | script | number | Value | Locking script |
| Funding | <Sig_{A}> | 0x00000001 | 0 | OP_FALSE OP_RETURN |
| Outpoint | <P_{A}> | | | <data₁> |
| | | | 1 BSV | [P2PKH Alice] |
| | | | 1 BSV | [P2PKH Bob] |

where data₁ consists of:

| | Field | | |
|---|---|---|---|
| Field | Length | Value | Explanation |
| Current | 64 bytes | A list of | A triplet is used to represent each |
| state | | triplets | piece on the board. 1 byte for the |
| of the | | (x, y, | location (x, y), and 1 byte for the |
| chessboard | | piece) | piece identifier. Maximum |
| | | | 32 pieces. Hence |
| | | | maximum 64 bytes. |
| Next | 2 bytes | (x₁, y₁) → | Move white_pawn_4 |
| Move | | (x₂, y₂) | from (4, 2) to (4, 4). |
| Events | N/A | Game | List of historical |
| | | starts | moves and events. This |
| | | | field can be optional. |

Once the chess oracle 102o receives the transaction or simply her move and signature from Alice, it checks whether Alice's move is valid. If it is, the chess oracle 102o adds its signature to the input of the transaction and passes it on to Bob for record. The chess oracle 102o then computes the new state of the chessboard. This new state will be included in the next transaction template for Bob. Since no piece is captured and no winning conditions are met, the fund will be evenly distributed between the two players in the next transaction template as in this one.

TxID′₁

| Version | | 1 | Locktime | T_{L}_{₁} |
|---|---|---|---|---|
| In-count | | 1 | Out-count | 3 |
| Input list | | | | |
| | Unlocking | Sequence | Output list | |
| Outpoint | script | number | Value | Locking script |
| Funding | <Sig_{A}> | 0x00000001 | 0 | OP_FALSE OP_ |
| Outpoint | <P_{A}> | | | RETURN |
| | <Sigₒ> | | | <data₁> |
| | | | 1 BSV | [P2PKH Alice] |
| | <Pₒ> | | 1 BSV | [P2PKH Bob] |

This marks the end of Move 1.

### Move 2:

Bob gets the second transaction template from the oracle 102o and fills in his move:

TxID₂

| Version | | 1 | Locktime | T_{L}_{₂} |
|---|---|---|---|---|
| In-count | | 1 | Out-count | 3 |
| Input list | | | | |
| | Unlocking | Sequence | Output list | |
| Outpoint | script | number | Value | Locking script |
| Funding | <Sig_{B}> | 0x00000002 | 0 | OP_FALSE OP_ |
| Outpoint | <P_{B}> | | | RETURN |
| | | | | <data₂> |
| | | | 1 BSV | [P2PKH Alice] |
| | | | 1 BSV | [P2PKH Bob] |

Note that the second transaction can be viewed as an updated version of the first transaction. The locktime T_{L}_{₂} is closer to the current time frame than T_{L}_{₁}. The sequence number is incremented by 1 to 0x00000002. The OP_RETURN data payload has been updated to reflect the current state of the chess board and Bob's next move. The transaction is then sent to the oracle 102o to verify and sign before being sent to Alice as in Move 1.

TxID′₂

| | | | |
|---|---|---|---|
| Version | 1 | Locktime | T_{L}_{₂} |
| In-count | 1 | Out-count | 3 |

| Input list | | | | |
|---|---|---|---|---|
| | Unlocking | Sequence | Output list | |
| Outpoint | script | number | Value | Locking script |
| Funding | <Sig_{B}> | 0x00000002 | 0 | OP_FALSE OP_ |
| Outpoint | <P_{B}> | | | RETURN |
| | <Sig_{O}> | | | <data₂> |
| | <P_{O}> | | 1 BSV | [P2PKH Alice] |
| | | | 1 BSV | [P2PKH Bob] |

### Move 3:

Similar to previous transactions, Alice fills in the third transaction with her move and sends to the oracle 102o-.

TxID₃

| Version | | 1 | Locktime | T_{L}_{₃} |
|---|---|---|---|---|
| In-count | | 1 | Out-count | 3 |
| Input list | | | | |
| | Unlocking | Sequence | Output list | |
| Outpoint | script | number | Value | Locking script |
| Funding | <Sig_{A}> | 0x00000003 | 0 | OP_FALSE OP_ |
| Outpoint | <P_{A}> | | | RETURN |
| | | | | <data₃> |
| | | | 1 BSV | [P2PKH Alice] |
| | | | 1 BSV | [P2PKH Bob] |

In this move, suppose that Alice captures Bob's pawn. The oracle 102o does all the computation and works out the new state of the chessboard and the corresponding outputs. However, the oracle 102o only incorporates these changes in the transaction template for Bob's next move. It signs the third transaction and passes it on to Bob.

TxID₃

| | | | |
|---|---|---|---|
| Version | 1 | Locktime | T_{L}_{₃} |
| In-count | 1 | Out-count | 3 |

| Input list | | | | |
|---|---|---|---|---|
| | Unlocking | Sequence | Output list | |
| Outpoint | script | number | Value | Locking script |
| Funding | <Sig_{A}> | 0x00000003 | 0 | OP_FALSE OP_ |
| Outpoint | <P_{A}> | | | RETURN |
| | <Sig_{O}> | | | <data₃> |
| | <P_{O}> | | 1 BSV | [P2PKH Alice] |
| | | | 1 BSV | [P2PKH Bob] |

When Bob receives Alice's move via the oracle 102o-, if he cheats and leaves the payment channel as he is losing, then either Alice or the oracle 102o can publish a transaction that reflects the outcome. Note that the funding transaction only requires two signatures to spend. Therefore, there is no incentive for Bob to leave the channel unilaterally.

The template for Bob's next move will look like this:

TxID₄

| Version | 1 | | Locktime | T_{L}_{₄} |
|---|---|---|---|---|
| In-count | 1 | | Out-count | 3 |
| Input list | | | | |
| | Unlocking | Sequence | Output list | |
| Outpoint | script | number | Value | Locking script |
| Funding | | 0x00000004 | 0 | OP_FALSE OP_RETURN |
| Outpoint | | | | <data₄> |
| | | | 1.05 BSV | [P2PKH Alice] |
| | | | 0.95 BSV | [P2PKH Bob] |

### Settlement

Suppose Alice wins the game in Move 21. Alice submits the 21^{st} transaction to the oracle 102o.

TxID₂₁

| Version | | 1 | Locktime | T_{L}_{₂₁} |
|---|---|---|---|---|
| In-count | | 1 | Out-count | 3 |
| Input list | | | | |
| | Unlocking | Sequence | Output list | |
| Outpoint | script | number | Value | Locking script |
| Funding | <Sig_{A}> | 0x00000015 | 0 | OP_FALSE OP_RETURN |
| Outpoint | <P_{A}> | | | <data₂₁> |
| | | | 1.5 BSV | [P2PKH Alice] |
| | | | 0.5 BSV | [P2PKH Bob] |

The oracle 102o verifies that Bob's king will be captured after Alice's move. If it is true, it signs and passes on the transaction to Bob, together with a template for the final transaction. When Bob receives the template, he accepts the defeat and signs the final transaction to settle the payment channel. If Bob chooses the leave the payment channel unilaterally, then Alice and the oracle 102o can sign the final transaction to settle the payment channel.

TxID_{final}

| Version | 1 | Locktime | | 0 |
|---|---|---|---|---|
| In-count | 1 | Out-count | | 2 |
| Input list | | | | |
| | Unlocking | Sequence | Output list | |
| Outpoint | script | number | Value | Locking script |
| Funding | <Sig_{B}> | 0xFFFFFFFF | 0 | OP_FALSE OP_RETURN |
| Outpoint | <P_{B}> | | | <data₂₂> |
| | | | 2 BSV | [P2PKH Alice] |

### 4.2 Proof of Work Payment Channel

In this scenario, Alice is a miner. She would like to delegate her mining computation to hash oracles. This corresponds to the scenario of FIG. 3B, with the oracles 102o−1, 102o−2 being hash oracles and (in this case) a single non-oracle participant (miner Alice).

Without loss of generality, two hash oracles 102o−1, 102o2—Olivia and Oscar for short—are assumed to be competing (there may be more than two competing oracles in practice).

To implement a form of “mining pool”, Alice will reduce the network difficulty to a reasonable level for her payment channel. That is to say, if the network requires a block hash≤BH for a valid block, Alice can set a computationally easier task of finding a nonce that yields a block hash<BH′ where BH′>BH.

She will reward participants each time they find a nonce that meets the criteria. She will hope that during the life time of the payment channel, one of the answers would produce a hash value that is small enough to meet the network difficulty.

The underlying idea is that each party seeks to solve a simpler problem than the block mining problem—in the hope that, in seeking to solve the simpler problem, one of them will eventually happen to solve the block mining problem (with each mining oracle being rewarded for their efforts—effectively pooling their efforts and receiving a share of the mining fee Alice hopes to eventually secure in return).

To open a PoW payment channel, participants submits a funding transaction.

TxID_{funding}

| Version | | 1 | Locktime | 0 |
|---|---|---|---|---|
| In-count | | 1 | Out-count | 2 |
| Input list | | | | |
| | Unlocking | Sequence | Output list | |
| Outpoint | script | number | Value | Locking script |
| Alice | <Sig_{A}> | 0xFFFFFFFF | 10 BSV | [P2PKH Alice] |
| Outpoint | <P_{A}> | | | [1-2 multiSig |
| | | | | Olivia, Oscar] |

The goal of the payment channel is to achieve:

While (OP_HASH256(data) >= difficulty) {
Do data = updated data
}
Return data

Once the payment channel is opened, both oracles are given a block header with missing nonce. They iterate the nonce and try to find a nonce that produces a hash value that is less than the difficulty.

Suppose Olivia finds one first. She submits a transaction to Alice:

TxID₁

| | | | |
|---|---|---|---|
| Version | 1 | Locktime | T_{L}_{₁} |
| In-count | 1 | Out-count | 3 |

| Input list | | | | |
|---|---|---|---|---|
| | Unlocking | Sequence | Output list | |
| Outpoint | script | number | Value | Locking script |
| Funding | <Sig_{Olivia}> | 0x00000001 | 0.1 BSV | [P2PKH Olivia] |
| Outpoint | <P_{Olivia}> | | | |
| | | | 9.9 BSV | [P2PKH Alice] |
| | | | 0 | OP_FALSE OP_ |
| | | | | RETURN |
| | | | | <nonce_Olivia> |

Alice checks that the nonce produces a hash value that is less than the difficulty. If it is the case, she signs the transaction and passes on to both Olivia and Oscar. Note that Alice can also implement an oracle that does all the verifications.

In this case, the functional unit F( ) is applied to determine the new distribution of digital asset between Alice and the mining oracles based on the determined nonce. The determined nonce is a parameter ωᵢ in the above terminology, determined externally from functional unit F( ).

In one implementation, the only input values are the digital asset values vᵢ, which are computed in dependence on the previous digital asset values vᵢ₋₁.

In another implementation, Alice is responsible for setting the digital asset values correctly (which Oracle's can verify before signing). In that case, there are no inputs ϕᵢ to the functional unit—only parameters ωᵢ.

Suppose Oscar finds the next one. He updates the transaction and submits it to Alice:

TxID₂

| Version | 1 | Locktime | T_{L}_{₂} | |
|---|---|---|---|---|
| In-count | 1 | Out-count | 4 | |
| Input list | | | | |
| | Unlocking | Sequence | Output list | |
| Outpoint | script | number | Value | Locking script |
| Funding | < Sig_{Oscar} > | 0x00000002 | 0.1 BSV | [P2PKH Olivia] |
| Outpoint | <P_{Oscar}> | | 0.1 BSV | [P2PKH Oscar] |
| | | | 9.8 BSV | [P2PKH Alice] |
| | | | 0 | OP_FALSE OP_RETURN |
| | | | | <nonce_Olivia> |
| | | | | <nonce_Oscar> |

Alice verifies the claim and signs the transaction if it is true.

It is Alice's responsibility to make sure that the distribution of the fund is correct. If Alice leaves the payment channel unilaterally, both Olivia and Oscar will publish the latest transaction to claim their reward. If Oscar left the payment channel unilaterally, then it is possible for the rest of the participants to claim all Oscar's reward in an updated transaction.

This design incentivises participants to stay in the payment channel as long as its life span. The payment channel can be closed when the funding is running out, or the initial lock time is about to expire, or a nonce that produces a small enough hash value is found.

It will be appreciated that the above embodiments have been described by way of example only.

More generally there may be provided a method, apparatus or program in accordance with any one or more of the following Statements.

Statement 1. A first aspect of the present disclosure provides a computer-implemented method of effecting a blockchain payment channel based on a series of spending transactions exchanged between parties, in which: a funding transaction, committed to a blockchain, comprises at least one spendable transaction output locked to at least two public keys of the parties, wherein the funding transaction contains or otherwise evidences a function for at least partially computing the series of spending transactions; each transaction of the series of spending transactions has a future lock time, before which it cannot be committed to the blockchain, and comprises: (i) at least one transaction input containing a pointer to the spendable transaction output of the funding transaction, and (ii) at least two spendable transaction outputs having respective digital asset values, an initial transaction of the series of spending transactions has a lowest sequence number and each subsequent transaction of the series of spending transactions has a higher sequence number than the previous transaction; wherein the method comprises, by one of the parties: receiving, at computer equipment of the party, a previous transaction of the series of spending transaction; using the function contained or otherwise evidenced in the funding transaction to at least partially compute the current transaction; and cryptographically signing a portion of the current transaction, the signed portion comprising the at least two spendable transaction outputs, using a private key counterpart to the public key of the party, thereby computing a transaction signature for inclusion in the transaction input of the current transaction.

The verb “to evidence” is used in a specific sense to mean that, given an actual piece of code or some other data evidenced in a transaction, it is possible to verify whether or not the actual data (e.g. code) matches the data (e.g. code) evidenced by the transaction. For example, the transaction may comprise a cryptograph hash of the data or some other unique identifier of the data. The term “cryptographic hash” is used in a broad sense to mean any hash value derived from a piece of data (e.g. a piece of code) via the application of one or more cryptographic hash functions (such as a single or double/multi hash of the piece of code, a root hash of a hash tree containing the piece of code etc.)

Example embodiments are set out below, as Statements 2 onwards.

Statement 2. The method of Statement 1, wherein said function is applied to at least the digital asset values of the previous transaction to compute the digital asset values of the current transaction.

Statement 3. The method of Statement 1 or 2, wherein each transaction of the series of spending transactions contains one or more input values;
wherein the function is applied to at least the one or more input values contained in the previous transaction to compute the one or more input values of the current transaction.

Statement 4. The method of Statements 2 and 3, wherein the function is applied to at least the one or more input values contained in the previous transaction to compute the digital asset values and the one or more input values of the current transaction.

Statement 5. The method of Statement 1, 2, 3 or 4, wherein each transaction of the series of spending transactions contains one or more external parameters which are not computed by applying the function;
wherein the function is applied to at least the one or more external parameters contained in the previous transaction in order to at least partially compute the current transaction.

Statement 6. The method of Statement 5 when dependent on Statement 3, wherein each transaction of the series of spending transactions comprises the one or more input values and the one or more external parameters, wherein the function is applied to the one or more input values and the one or more external parameters contained in the previous transaction.

Statement 7. The method of any preceding Statement, wherein the digital asset values of the current transaction are computed by said applying of the function.

Statement 8. The method of any preceding Statement, wherein the final transaction in the series is used to compute a settlement transaction, using the same function to compute respective digital asset values of at least two spendable transaction outputs of the settlement transaction, wherein the settlement transaction comprises at least one transaction input containing a pointer to the spendable transaction output of the funding transaction, wherein the settlement transaction is committed to the blockchain.

Statement 9. The method of Statement 8, wherein the settlement transaction contains or otherwise evidences one or more function variables to which the function is applied in order to compute the digital asset values of the spending transaction.

Statement 10. The method of Statement 9, wherein the settlement transaction contains a cryptographic hash of the one or more function variables, and thereby evidences the one or more least one function variables.

Statement 11. The method of Statement 10, wherein the cryptographic hash is a root hash of a hash tree evidencing the one or more function variables.

Statement 12. The method of any preceding Statement, wherein said applying of the function creates a new data field for the current transaction, which does not correspond to any existing data field contained in the previous transaction, the current transaction containing the new data field.

Statement 13. The method of any preceding Statement, wherein said applying of the function prevents an existing type of data field from being propagated from the previous transaction into the current transaction, such that the previous transaction contains a data field which does not correspond to any data field in the current transaction.

Statement 14. The method of any preceding Statement, wherein the spendable transaction output of the funding transaction specifies m public keys of the parties and is locked to any 2≤n<m of the m public keys, the party applying the function being a trusted oracle, whereby any other n−1 of the parties may sign a portion of the current transaction for unlocking the spendable transaction output of the funding transaction.

Where n=2, “n−1 of the parties” means a single other party. The other n−1 party/parties may sign the portion of the current transaction before, after or simultaneously with the trusted oracle. The trusted oracle may be the only trusted oracle of the parties or two or more of the parties may be trusted oracles.

Statement 15. The method of Statement 14, wherein the trusted oracle signs the current transaction after receiving, from another of the parties, at least a transaction signature for the current transaction which is valid in respect of the public of the other party.

The trusted oracle may add the other party's transaction signature to the transaction input of the current transaction, along with the trusted oracle's signature, or the trusted oracle may send the signatures elsewhere to be added to the current transaction. Alternatively, the trusted oracle may send his/her/its transaction signature to another of the parties or to an external source for that other party/external source to add to the current transaction. The transaction signature may be received alone, or along with a full copy of the current transaction (for example), or more generally along with one or more components of the current transaction.

Statement 16. The method of Statement 15, wherein the trusted oracle uses the funding transaction to determine or verify the function to be applied.

Statement 17. The method of any preceding Statement, wherein the funding transaction contains or evidences a piece of code executable embodying the function, the function being applied by executing the piece of code on one or more computer processors of the computer equipment.

Statement 18. The method of Statement 17, wherein the piece of code is contained in:
the funding transaction, or
another transaction recorded in the blockchain, and in that event the funding transaction contains an identifier of the piece of code.

Statement 19. The method of Statement 18 when dependent on Statement 16, wherein the trusted oracle retrieves the piece of code from the blockchain for execution, and thereby determines the function to be applied.

Statement 20. The method of Statement 18 or 19 when dependent on Statement 16, wherein the trusted oracle receives the piece of code from an off-chain source and uses the funding transaction to verify the received piece of code.

Statement 21. The method Statement 5 or any Statement dependent thereon, wherein the one or more external parameters of the current transaction are provided by another of the parties, other than the party applying the function.

Statement 22. The method of Statement 21, wherein the one or more external parameters of the current transaction are contained in the signed portion of the current transaction, and the party signs the current transaction after the other party has provided the one or more external parameters.

Statement 23. The method of Statement 3 or any Statement dependent thereon, wherein the party also applies the same function to at least the one or more input values of the current transaction, in order to compute: (a′) one or more input values of the next transaction, the next transaction being the transaction after the current transaction in the series of spending transactions, and (b′) the digital asset values of the next transaction.

Statement 24. The method of Statement 5 or any Statement dependent thereon, wherein the party applies the same function to at least the one or more external parameters of the current transaction in order to compute the digital asset values of the next transaction.

Statement 25. The method of Statement 23 or 24, wherein the party creates the next transaction containing at least the digital asset values of the next transaction, cryptographically signs a portion of the next transaction, and sends the next transaction and the transaction signature to another of the parties.

Statement 26. The method of Statement 6 or any Statement dependent thereon, wherein:
the one or more input values in each transaction of the series of spending transactions represent a game state, and
the one or more external parameters in the previous transaction define a game move, the one or more external parameters in the previous transaction having been determined by a second of the parties,
wherein the function is applied to update the game state of the previous transaction to implement the game move of the previous transaction, the updated game state represented by the one or more input values of the current transaction, whereby the digital asset values of the current transaction are computed responsive to the game move.

Statement 27. The method of Statement 26, wherein the current transaction is sent to a third of the parties for the third party to determine the one or more external parameters for the current transaction, representing the third party's game move responsive to the second party's game move.

In some such embodiments, the party applying the function to update the game state is a trusted oracle. The function captures a set of game rules for validating game moves and updating the game state responsive to valid game moves. Where the function is committed/evidenced in the blockchain, the rules of the game may be entirely defined by the blockchain (or at least unambiguously verifiable from the blockchain).

Statement 28. The method of any preceding Statement, wherein the one or more input values of the current transaction are contained in the signed portion of the current transaction.

Statement 29. The method of any preceding Statement, wherein the party applies the function after the previous transaction has been signed by at least two of the parties.

Statement 30. The method of Statement 5 or any Statement dependent thereon, wherein the one or more external parameters of the previous transaction comprise a nonce value, wherein the function is applied to:
add the nonce value to a partial data set, thereby determining a complete data set including the nonce value,
apply a hash function to the complete data set, thereby computing a hash value,
determine if the hash value meets a defined requirement, and
determine the digital asset values of the current transaction in dependence on whether the hash value meets the defined requirement.

Statement 31. The method of any preceding Statement, wherein the final transaction in the series is used to compute a settlement transaction, by applying the same function to one or more function variables of the final transaction to compute respective digital asset values of at least two spendable transaction outputs of the settlement transaction, wherein the settlement transaction comprises at least one transaction input containing a pointer to the spendable transaction output of the funding transaction, wherein the settlement transaction is committed to the blockchain.

Statement 32. The method of Statement 31, wherein the settlement transaction has a maximum possible sequence number.

In that case, it may be unnecessary for the settlement transaction to have a future lock time, i.e. it may be that no conditions are imposed on when the settlement transaction can be committed. The settlement transaction may also contain one or more function variables of the same kind, or it may not contain any such function variables (because it may be that no such function variable(s) are required because no further transaction is to be computed).

Statement 33. The method of any preceding Statement, wherein the function is not applied to compute the digital asset values of the current transaction until the previous transaction has been finalized at least by the application of two or more required transaction signatures.

Statement 34. Computer equipment comprising one or more computer processors, the one or more computer processors being configured to implement the method of any preceding Statements.

Statement 35. Computer program instructions stored on a transitory or non-transitory computer-readable medium or media, the computer program instructions for programming computer equipment to carry out the steps of any of Statements 1 to 33.

Statement 36. Another aspect provides a funding transaction for recording in a blockchain, the funding transaction embodied on a transitory or non-transitory computer-readable medium or media and comprising:
at least one spendable output locked to at least two public keys;
wherein the funding transaction contains or otherwise evidences a function for determining, in dependence on one or more function variables, a distribution between at least two parties of an amount of digital asset conveyed by the at least one spendable output of the funding transaction.

Statement 37. The funding transaction of Statement 36, wherein the function is embodied as a piece of code contained or otherwise evidenced in the funding transaction, the piece of code configured, when executed on one or more computer processors, in dependence on the one or more function variables, to determine the distribution of the amount of digital asset.

Statement 38. The funding transaction of Statement 37, wherein the piece of code is coded in a script language of a blockchain protocol to which the funding transaction conforms.

Statement 39. The funding transaction of Statement 38, wherein the piece of code is coded in a computer programming language other than a script language of a blockchain protocol to which the funding transaction conforms.

Statement 40. The funding transaction of any preceding Statement, which contains cryptographic hash of the function, and thereby evidences the function.

Statement 41. The funding transaction according to any of Statements 36 to 40, wherein the spendable output specifies m public keys of the parties and is locked to any 2≤n<m of the m public keys.

Statement 42. The funding transaction of any of Statements 36 to 41, wherein the funding transaction conforms to a blockchain protocol but the validity of the funding transaction with respect to the blockchain protocol is independent of said function, whereby a blockchain node applying the blockchain protocol will to validate the funding transaction will not apply the function or will apply the function but will ignore the result for the purpose of validating the funding transaction.

Statement 43. Another aspect provides a settlement transaction for recording in a blockchain, the settlement transaction embodied on a transitory or non-transitory computer-readable medium or media and comprising:
1) at least one input containing:
a pointer to a spendable output of a funding transaction, the spendable output of the funding transaction locked to at least two public keys, and
at least two transaction signatures, each valid in respect of a different one of the at least two public keys to which the spendable out is locked for unlocking the spendable output of the funding transaction; and
2) at least two spendable outputs having respective digital asset values, the digital asset values defining a distribution, between at least two parties, of an amount of digital asset conveyed, at least in part, by the spendable output of the funding transaction;
wherein the settlement transaction contains or otherwise evidences at least one function variable for applying a function, as defined or otherwise evidenced in the funding transaction, to verify the distribution of the amount of digital asset.

Statement 44. The settlement transaction of Statement 43, which contains a cryptographic hash of the at least one function variable, and thereby evidences the at least one function variable.

Statement 45. The settlement transaction of Statement 44, wherein the cryptographic hash is a root hash of a hash tree in which the at least one function variable is evidenced.

Statement 46. A set of blockchain transactions comprising the funding transaction of any of Statements 36 to 42 and the settlement transaction of any of Statements 43 to 44.

According to another aspect disclosed herein, there may be provided a method comprising the actions of the first party, second party, any third party that may be involved, and the network of nodes.

According to another aspect disclosed herein, there may be provided a system comprising the computer equipment of the first party, the computer equipment of the second party, the computer equipment of any third party, and the network of nodes.

Other variants or use cases of the disclosed techniques may become apparent to the person skilled in the art once given the disclosure herein. The scope of the disclosure is not limited by the described embodiments but only by the accompanying claims.

1. A computer-implemented method of effecting a blockchain payment channel based on a series of spending transactions exchanged between parties, in which:
a funding transaction, committed to a blockchain, comprises at least one spendable transaction output locked to at least two public keys of the parties, wherein the funding transaction contains or otherwise evidences a function for at least partially computing the series of spending transactions;
each transaction of the series of spending transactions has a future lock time, before which the transaction cannot be committed to the blockchain, and comprises: (i) at least one transaction input containing a pointer to the spendable transaction output of the funding transaction, and (ii) at least two spendable transaction outputs having respective digital asset values,
an initial transaction of the series of spending transactions has a lowest sequence number and each subsequent transaction of the series of spending transactions has a higher sequence number than the previous transaction;
wherein the method comprises, by a party of the parties:
receiving, at computer equipment of the party, a previous transaction of the series of spending transaction;
using the function contained or otherwise evidenced in the funding transaction to at least partially compute a current transaction; and
cryptographically signing a portion of the current transaction, the signed portion comprising the at least two spendable transaction outputs, using a private key counterpart to the public key of the party, thereby computing a transaction signature for inclusion in the transaction input of the current transaction.

2. The method of claim 1, wherein said function is applied to at least the digital asset values of the previous transaction to compute the digital asset values of the current transaction.

3. The method of claim 1, wherein each transaction of the series of spending transactions contains one or more input values;
wherein the function is applied to at least the one or more input values contained in the previous transaction to compute the one or more input values of the current transaction.

4. (canceled)

5. The method of claim 1, wherein each transaction of the series of spending transactions contains one or more external parameters which are not computed by applying the function;
wherein the function is applied to at least the one or more external parameters contained in the previous transaction in order to at least partially compute the current transaction.

6. (canceled)

7. The method of claim 1, wherein the digital asset values of the current transaction are computed by said applying of the function.

8. The method of claim 1, wherein a final transaction in the series is used to compute a settlement transaction, using the same function to compute respective digital asset values of at least two spendable transaction outputs of the settlement transaction, wherein the settlement transaction comprises at least one transaction input containing a pointer to the spendable transaction output of the funding transaction, wherein the settlement transaction is committed to the blockchain.

9. The method of claim 8, wherein the settlement transaction contains or otherwise evidences one or more function variables to which the function is applied in order to compute the digital asset values of the spending transaction.

10-11. (canceled)

12. The method of claim 1, wherein said applying of the function creates a new data field for the current transaction, which does not correspond to any existing data field contained in the previous transaction, the current transaction containing the new data field.

13. The method of claim 1, wherein said applying of the function prevents an existing type of data field from being propagated from the previous transaction into the current transaction, such that the previous transaction contains a data field which does not correspond to any data field in the current transaction.

14. The method of claim 1, wherein the spendable transaction output of the funding transaction specifies m public keys of the parties and is locked to any 2≤n<m of the m public keys, the party applying the function being a trusted oracle, whereby any other n−1 of the parties may sign a portion of the current transaction for unlocking the spendable transaction output of the funding transaction.

15. The method of claim 14, wherein the trusted oracle signs the current transaction after receiving, from another of the parties, at least a transaction signature for the current transaction which is valid in respect of the public of the other party.

16. (canceled)

17. The method of claim 1, wherein the funding transaction contains or evidences a piece of executable code embodying the function, the function being applied by executing the piece of executable code on one or more computer processors of the computer equipment.

18. The method of claim 17, wherein the piece of executable code is contained in:
the funding transaction, or
another transaction recorded in the blockchain, and in that event the funding transaction contains an identifier of the piece of executable code.

19-34. (canceled)

35. A non-transitory computer-readable medium storing computer program instructions, the computer program instructions being configured to, when executed by computer equipment, cause the computer equipment to carry out the steps of effecting a blockchain payment channel based on a series of spending transactions exchanged between parties, in which:
a funding transaction, committed to a blockchain, comprises at least one spendable transaction output locked to at least two public keys of the parties, wherein the funding transaction contains or otherwise evidences a function for at least partially computing the series of spending transactions;
each transaction of the series of spending transactions has a future lock time, before which it cannot be committed to the blockchain, and comprises: (i) at least one transaction input containing a pointer to the spendable transaction output of the funding transaction, and (ii) at least two spendable transaction outputs having respective digital asset values,
an initial transaction of the series of spending transactions has a lowest sequence number and each subsequent transaction of the series of spending transactions has a higher sequence number than a previous transaction;
wherein when the computer program instructions are executed on a computing device of one of the parties, the computing device to perform the steps of:
receiving, at computer equipment of the party, a previous transaction of the series of spending transaction;
using the function contained or otherwise evidenced in the funding transaction to at least partially compute a current transaction; and
cryptographically signing a portion of the current transaction, the signed portion comprising the at least two spendable transaction outputs, using a private key counterpart to the public key of the party, thereby computing a transaction signature for inclusion in the transaction input of the current transaction.

36. A funding transaction for recording in a blockchain, the funding transaction embodied on a non-transitory computer-readable medium or media and comprising:
at least one spendable output locked to at least two public keys;
wherein the funding transaction contains or otherwise evidences a function for determining, in dependence on one or more function variables, a distribution between at least two parties of an amount of digital asset conveyed by the at least one spendable output of the funding transaction.

37. The funding transaction of claim 36, wherein the function is embodied as a piece of code contained or otherwise evidenced in the funding transaction, the piece of code configured, when executed on one or more computer processors, in dependence on the one or more function variables, to determine the distribution of the amount of digital asset.

38. The funding transaction of claim 37, wherein the piece of code is coded in a script language of a blockchain protocol to which the funding transaction conforms.

39. (canceled)

40. The funding transaction of claim 36, wherein the funding transaction contains a cryptographic hash of the function, and thereby evidences the function.

41. The funding transaction of claim 36, wherein the spendable output specifies m public keys of the parties and is locked to any 2≤n<m of them public keys.

42. (canceled)

43. A settlement transaction for recording in a blockchain, the settlement transaction embodied on a non-transitory computer-readable medium or media and comprising:
1) at least one input containing:
a pointer to a spendable output of a funding transaction, the spendable output of the funding transaction locked to at least two public keys, and
at least two transaction signatures, each valid in respect of a different one of the at least two public keys to which the spendable out is locked for unlocking the spendable output of the funding transaction; and
2) at least two spendable outputs having respective digital asset values, the digital asset values defining a distribution, between at least two parties, of an amount of digital asset conveyed, at least in part, by the spendable output of the funding transaction;
wherein the settlement transaction contains or otherwise evidences at least one function variable for applying a function, as defined or otherwise evidenced in the funding transaction, to verify the distribution of the amount of digital asset.

44-46. (canceled)
